(19) United States
(12) Patent Application Publication
(10) Pub. No.: US 2025/0353202 A1
(43) Pub. Date: Nov. 20, 2025

(54) PEELER, PEELING DEVICE, AND PEELING METHOD

(71) Applicant: NAGAKI SEIKI CO., LTD., Osaka (JP)

(72) Inventors: Takayuki NAGAKI, Osaka (JP); Tamotsu IWAMA, Osaka (JP)

(21) Appl. No.: 18/881,603

(22) PCT Filed: Jun. 29, 2023
(86) PCT No.: PCT/JP2023/024114

§ 371 Date: Jan. 6, 2025

(30) Foreign Application Priority Data
Jul. 6, 2022 (JP) 2022-108896

(51) Int. Cl. B26D 3/28; B26D 7/01; H02G 1/12

(52) U.S. Cl. CPC B26D 3/282; B26D 7/01; H02G 1/1221; B26D 2007/013

(57) ABSTRACT

An object is to provide a wire stripper. The wire stripper includes: a wire stripper body having a first member, a second member and a first passage; a blade body attached to the second member and configured to separate the sheathed wire into a sheath layer and a core wire; a press plate part arranged to the first member so as to face the blade body and having a press surface configured to press the sheathed wire against the blade body; and a distance adjusting member configured to adjust the distance between the first member and the second member. The first member has a first guide part defining a part of the first passage and configured to guide relative motion of the wire stripper body relative to the sheathed wire. The press plate part protrudes on the first passage side from the first guide part.

### TECHNICAL FIELD

The present invention relates to a wire stripper, a wire stripping device, and a wire stripping method.

### BACKGROUND ART

Wire strippers used for stripping a sheath layer from a sheathed wire to expose a core wire are known.

As a related art, Patent Literature 1 discloses a sheath stripping device. The sheath stripping device disclosed in Patent Literature 1 has a sheath stripping tool and a rotary drive tool. The sheath stripping tool has a pair of holding members having an electric wire holder and a stripping blade protruding to the electric wire holder. The rotary drive tool has a rotary disc, a rotation transmission unit attached to the tip of a remote operating rod and configured to transfer rotation of a rotary shaft of the remote operating rod to the rotation of the rotary disc, and a sheath stripping tool holder for attaching the sheath stripping tool to the rotary disc in a tiltable manner.

### CITATION LIST

### Patent Literature

Patent Literature 1: Japanese Patent Application Laid-Open No. 2009-60753

### SUMMARY OF INVENTION

### Technical Problem

An object of the present invention is to provide a wire stripper, a wire stripping device, and a wire stripping method that can smoothly perform stripping work on a sheath layer.

### Solution to Problem

The present invention relates to a wire stripper, a wire stripping device, and a wire stripping method illustrated below.

(1) A wire stripper including:
a wire stripper body having a first member, a second member arranged facing the first member, and a first passage defined by the first member and the second member and configured to receive a part of a sheathed wire to be arranged;
a blade body attached to the second member and configured to separate the sheathed wire into a sheath layer and a core wire when the wire stripper body is relatively rotated with respect to the sheathed wire;
a press plate part arranged to the first member so as to face the blade body and having a press surface configured to press the sheathed wire against the blade body; and
a distance adjusting member configured to adjust the distance between the first member and the second member,
wherein the first member has a first guide part defining a part of the first passage and configured to guide relative motion of the wire stripper body relative to the sheathed wire, and
wherein the press plate part protrudes on the first passage side from the first guide part.
   (2) The wire stripper according to (1) above,
wherein the second member has an auxiliary guide part defining a part of the first passage and configured to guide the relative motion of the wire stripper body relative to the sheathed wire, and
wherein when viewed in a direction along the first passage, the diameter of a first virtual circular cylinder inscribed in both the press plate part and the auxiliary guide part is smaller than the diameter of a second virtual circular cylinder inscribed in both the first guide part and the auxiliary guide part.
   (3) The wire stripper according to (1) above, wherein when viewed in a direction along the first passage, the press surface has a V-shape.
   (4) The wire stripper according to (1) above, wherein a direction parallel to the first passage is defined as a first direction, a direction from the second member to the first member is defined as a second direction, and a direction perpendicular to both the first direction and the second direction is defined as a third direction, and when viewed in a direction along the second direction, the press plate part is inclined with respect to the third direction.
   (5) The wire stripper according to (1) above,
wherein the first guide part has a guide plate configured to guide the sheathed wire, and
wherein the guide plate has a V-shaped guide groove.
   (6) The wire stripper according to (1) above, wherein the first guide part has an inclined guide plate configured to assist helical movement of the wire stripper body relative to the sheathed wire.
   (7) The wire stripper according to (6) above,
wherein the first member has a top wall supporting the first guide part, and
wherein the inner surface of the top wall is inclined with respect to the first passage so as to be substantially perpendicular to the inclined guide plate.
   (8) The wire stripper according to (1) above,
wherein a direction in which the sheathed wire enters the first passage in stripping of the sheathed wire is defined as a first direction, and a blade edge of the blade body is inclined away from the first passage toward the first direction, and
wherein a direction from the first member to the second member is defined as a fourth direction, and when viewed in a direction along the fourth direction, the blade edge of the blade body has a substantially circular-arc shape.
   (9) The wire stripper according to (1) above, wherein the press plate part is detachably attached to the first member.
   (10) The wire stripper according to (1) above, wherein the distance adjusting member has
a threaded rod screwed into both the first member and the second member,
a guide rod inserted in both the first member and the second member and configured to guide relative motion of the first member relative to the second member, and
an operating part configured to relatively rotate the threaded rod with respect to both the first member and the second member.
   (11) The wire stripper according to (1) above further including:
a second blade body attached to one of the first member and the second member and configured to separate a second sheathed wire into a second sheath layer and a second core wire, the second sheathed wire being thinner than the sheathed wire; and
a second press plate part arranged to the other of the first member and the second member so as to face the second blade body and having a second press surface configured to press the second sheathed wire against the second blade body,
wherein the wire stripper body has
   a second passage defined by the first member and the second member and configured to receive a part of the second sheathed wire to be arranged, and
   a second guide part arranged to the other of the first member and the second member so as to define a part of the second passage and configured to guide relative motion of the wire stripper body relative to the second sheathed wire, and
wherein the second press plate part protrudes on the second passage side from the second guide part.
   (12) The wire stripper according to (1) above further including an anti-falling-off plate configured to prevent the sheathed wire from falling off of the first passage via a first side opening between the first member and the second member,
wherein the anti-falling-off plate is attached to at least one of an end of the first member in a direction along the first passage and an end of the second member in the direction along the first passage.
   (13) The wire stripper according to (1) above,
wherein the second member has an auxiliary guide part defining a part of the first passage and configured to guide the relative motion of the wire stripper body relative to the sheathed wire, and
wherein the auxiliary guide part has a plate part inclined so as to assist helical movement of the wire stripper body relative to the sheathed wire.
   (14) The wire stripper according to (1) above,
wherein the first guide part has a guide plate configured to guide the sheathed wire,
wherein the guide plate has a guide surface facing the second member and configured to come into contact with the sheathed wire, and
wherein the width of the guide surface in a direction along the first passage is smaller than the width of the press surface in the direction along the first passage.
   (15) A wire stripping device including:
the wire stripper according to any one of (1) to (14) above; and
a drive force transmission device including a rotating body and an attaching part for attaching the wire stripper to the rotating body, the drive force transmission device being configured to convert external drive force into rotary movement of the rotating body about a rotation axis that matches an extending direction of the first passage.
   (16) A wire stripping method for stripping a sheath layer from a sheathed wire by using a wire stripper,
wherein the wire stripper includes
   a wire stripper body having a first member, a second member arranged facing the first member, and a first passage defined by the first member and the second member and configured to receive a part of a sheathed wire to be arranged,
   a blade body attached to the second member, and
   a press plate part arranged to the first member so as to face the blade body and having a press surface configured to press the sheathed wire against the blade body, and
wherein the first member has a first guide part defining a part of the first passage and configured to guide relative motion of the wire stripper body relative to the sheathed wire, and
the wire stripping method including:
an arrangement step of arranging a part of the sheathed wire in the first passage;
a gripping step of gripping the sheathed wire between the press plate part arranged to the first member and the blade body attached to the second member by reducing the distance between the first member and the second member; and
a separation step of separating the sheathed wire into the sheath layer and a core wire by the blade body by relatively rotating the wire stripper body with respect to the sheathed wire,
wherein in a state immediately after the gripping step, force of the press plate part pressing the sheathed wire is larger than force of the first guide part pressing the sheathed wire.
   (17) The wire stripping method according to (16) above,
wherein the press plate part is spaced apart from the sheathed wire by performing the separation step, and
wherein in the separation step, in response to relative rotation of the wire stripper body with respect to the sheathed wire with the press plate part being spaced apart from the sheathed wire, the blade body and the first guide part in contact with the sheathed wire cooperate with each other to assist helical movement of the wire stripper body relative to the sheathed wire.

### Advantageous Effects of Invention

According to the present invention, a wire stripper, a wire stripping device, and a wire stripping method that can smoothly perform stripping work on a sheath layer can be provided.

### BRIEF DESCRIPTION OF DRAWINGS

FIG. 1 is a schematic two-side view schematically illustrating a wire stripper of a first embodiment.

FIG. 2 is a schematic two-side view schematically illustrating a state after a sheathed wire has been arranged in a wire stripper body of the wire stripper of the first embodiment.

FIG. 3 is a schematic front view schematically illustrating the wire stripper of the first embodiment.

FIG. 4 is a schematic front view schematically illustrating a state after the sheathed wire has been arranged in the wire stripper body of the wire stripper of the first embodiment.

FIG. 5 is an arrow E-E sectional view in FIG. 1.

FIG. 6 is a schematic side view schematically illustrating a state after the sheathed wire has been arranged in the wire stripper body of the wire stripper of the first embodiment.

FIG. 7 is an enlarged schematic front view illustrating a part of the wire stripper of the first embodiment.

FIG. 8 is a schematic three-side view schematically illustrating an example of a press plate part.

FIG. 9 is an arrow F-F sectional view in FIG. 1.

FIG. 10 is an arrow F-F sectional view in FIG. 1.

FIG. 11 is a schematic side view schematically illustrating a situation where the press plate part is attached to a first member.

FIG. 12 is a schematic side view schematically illustrating a state after a sheathed wire C has been arranged in the wire stripper body of the wire stripper of the first embodiment.

FIG. 13 is a schematic side view schematically illustrating a situation where stripping work on the sheathed wire is being performed by the wire stripper of the first embodiment

FIG. 14 is a schematic side view schematically illustrating the wire stripper of the first embodiment.

FIG. 15 is a schematic three-side view schematically illustrating an example of the first member.

FIG. 16 is a schematic side view schematically illustrating a situation where a blade body is attached to a second member.

FIG. 17 is a schematic two-side view schematically illustrating a state after a second sheathed wire has been arranged in the wire stripper body of the wire stripper of the first embodiment.

FIG. 18 is a schematic front view schematically illustrating the wire stripper of the first embodiment.

FIG. 19 is a schematic front view schematically illustrating the wire stripper of the first embodiment.

FIG. 20 is a schematic front view schematically illustrating a wire stripper of a second embodiment.

FIG. 21 is a schematic side view schematically illustrating a wire stripping device of a third embodiment.

FIG. 22 is a flowchart illustrating an example of a wire stripping method of an embodiment.

FIG. 23 is a schematic front view schematically illustrating a wire stripper of a modified example for embodiments.

FIG. 24 is a schematic side view schematically illustrating the wire stripper of the modified example for embodiments.

FIG. 25 is a schematic front view schematically illustrating an example of an anti-falling-off plate.

FIG. 26 is a schematic front view schematically illustrating a wire stripper of a modified example for embodiments.

FIG. 27 is a schematic side view schematically illustrating a state after a sheathed wire has been arranged in a wire stripper body of a wire stripper of a second modified example for embodiments.

FIG. 28 is a schematic side view schematically illustrating a state after a sheathed wire has been arranged in a wire stripper body of a wire stripper of a third modified example for embodiments.

FIG. 29 is a schematic sectional view schematically illustrating an example of a sheathed wire with a fin stripped by a wire stripper.

FIG. 30 is a schematic bottom view schematically illustrating an example of the first member to which the press plate part is attached.

FIG. 31 is a schematic bottom view schematically illustrating another example of the first member to which the press plate part is attached.

FIG. 32 is a schematic plan view schematically illustrating an example of the second member to which a blade body is attached.

FIG. 33 is a photograph substitute for a drawing, which is a photograph illustrating a result of a wire stripping test 1 performed by using the wire stripper of the embodiments.

FIG. 34 is a photograph substitute for a drawing, which is a photograph illustrating a result of a wire stripping test 2 performed by using the wire stripper of the embodiments.

FIG. 35 is a photograph substitute for a drawing, which is a photograph illustrating a result of a wire stripping test 3 performed by using the wire stripper of the embodiments.

### DESCRIPTION OF EMBODIMENTS

A wire stripper 1, a wire stripping device 100, and a wire stripping method of embodiments will be described below in detail with reference to the drawings. Note that, in the present specification, members having the same type of functions are labeled with the same or similar references. Further, for the members labeled with the same or similar references, the duplicated description thereof may be omitted.

### Definition of Directions

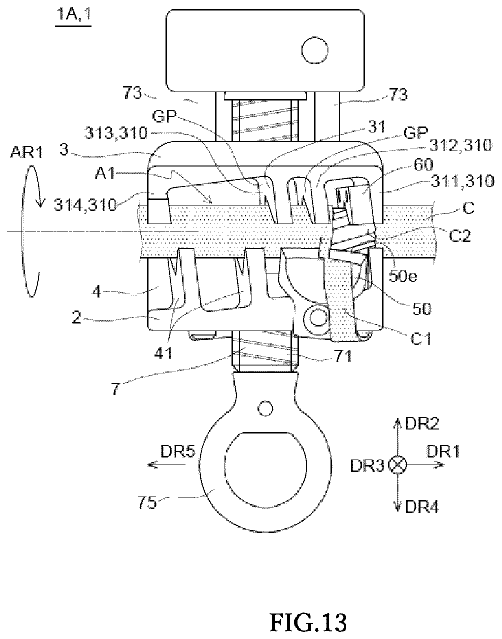

In the present specification, a direction parallel to a first passage A1 of a wire stripper body 2 is defined as “first direction DR1”. A part of a sheathed wire C is arranged in the first passage A1. In the example illustrated in FIG. 13, the first direction DR1 matches the direction in which the sheathed wire C enters the first passage A1 when the sheathed wire C is stripped.

In the present specification, a direction from a second member 4 of the wire stripper body 2 to a first member 3 of the wire stripper body 2 is defined as “second direction DR2”.

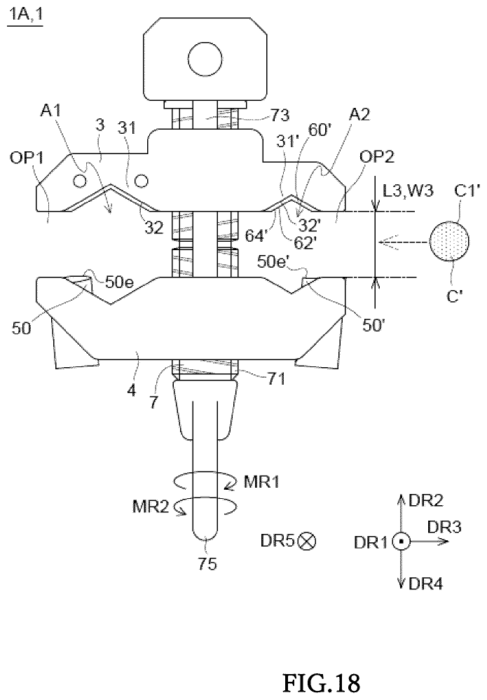

In the present specification, a direction perpendicular to both the first direction DR1 and the second direction DR2 is defined as “third direction DR3”. In the example illustrated in FIG. 18, the third direction DR3 matches the direction from the first passage A1 of the wire stripper body 2 to the second passage A2 of the wire stripper body 2.

In the present specification, a direction from the first member 3 of the wire stripper body 2 to the second member 4 of the wire stripper body 2 is defined as “fourth direction DR4”.

In the present specification, the direction opposite to the direction in which the sheathed wire C enters the first passage A1 when the sheathed wire C is stripped is defined as “fifth direction DR5”. In the example illustrated in FIG. 13, the fifth direction DR5 is the direction opposite to the first direction DR1.

### First Embodiment

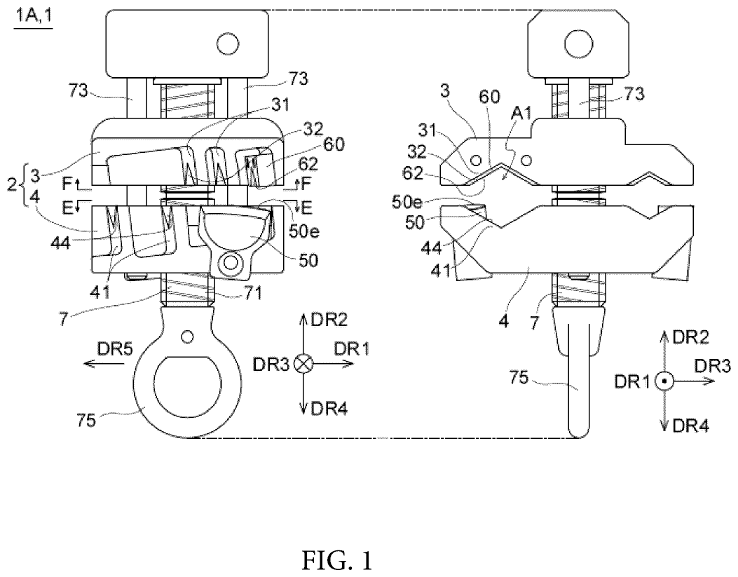

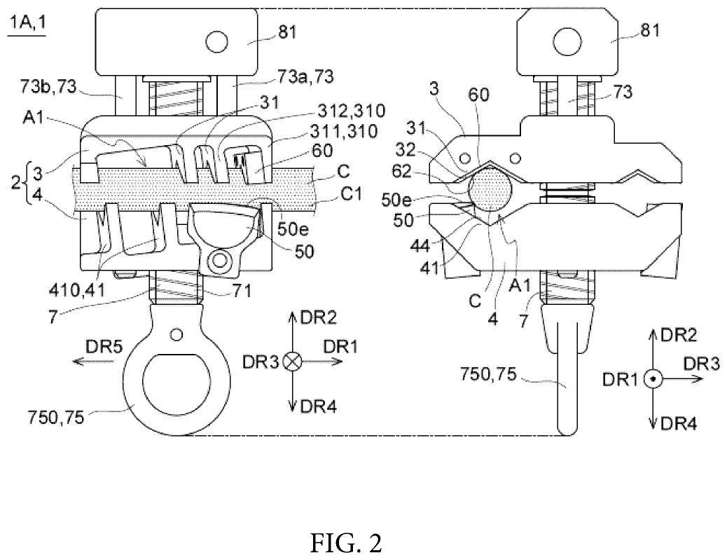

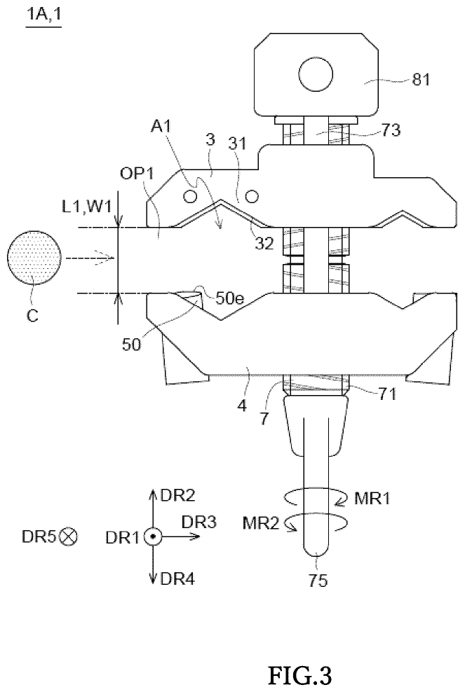

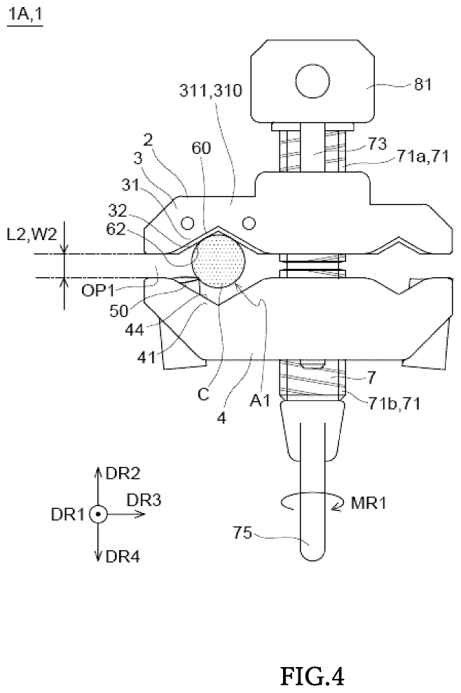

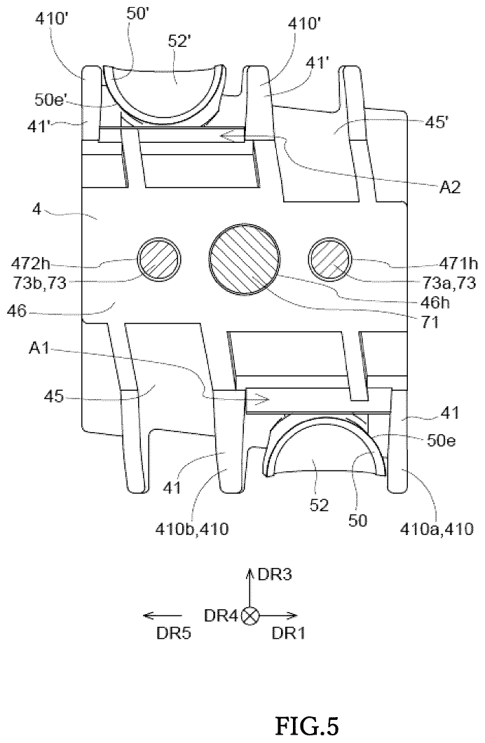

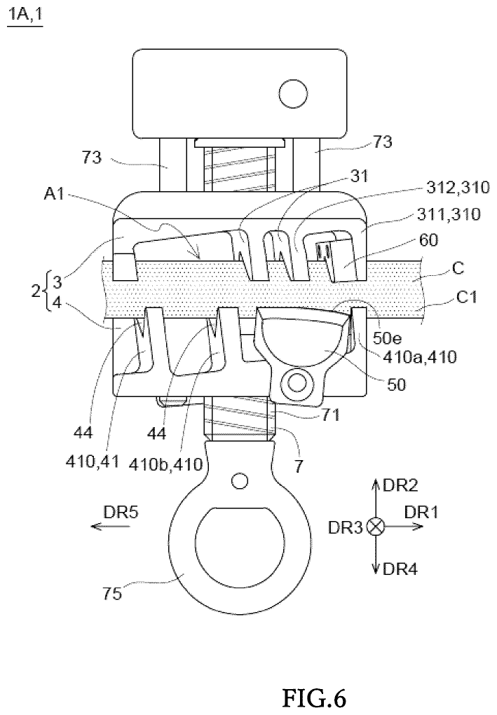

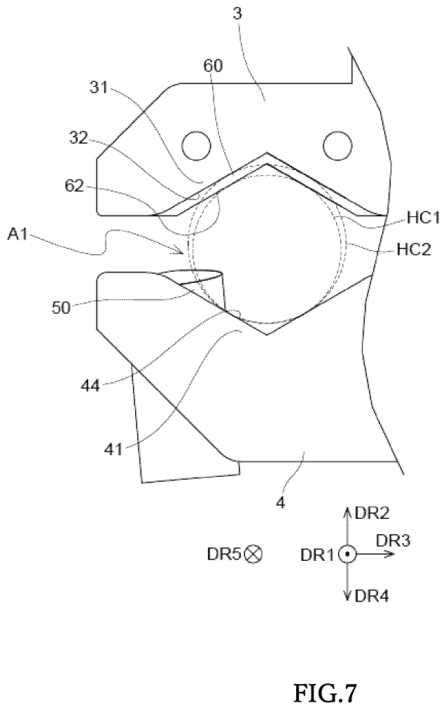

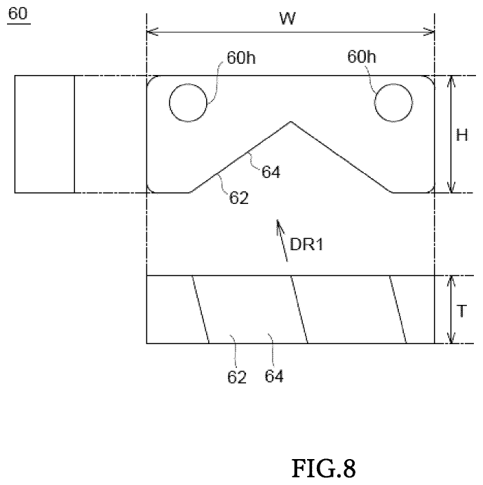

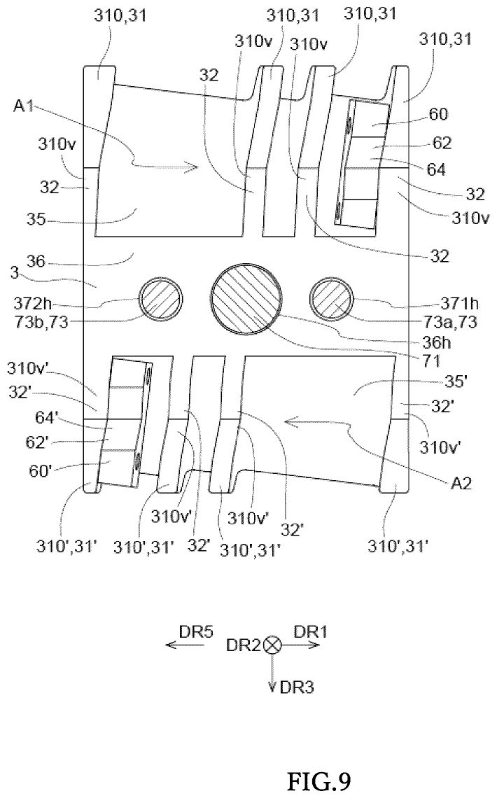

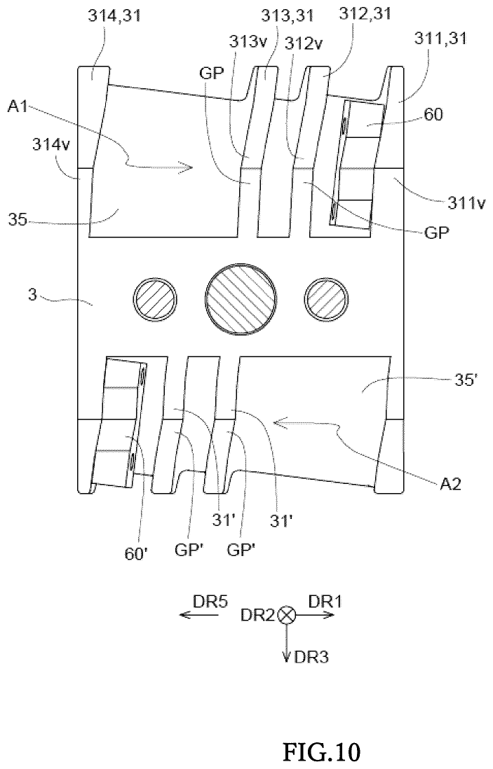

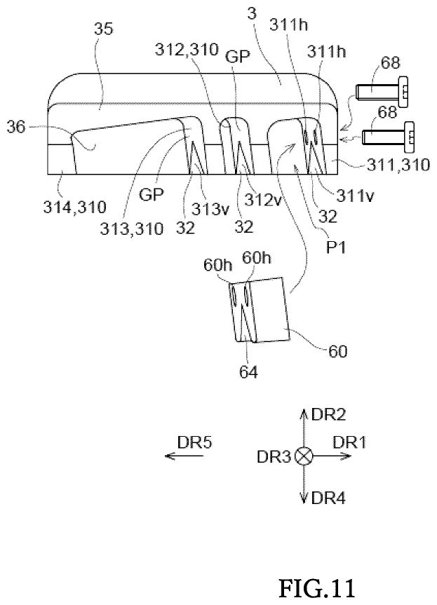

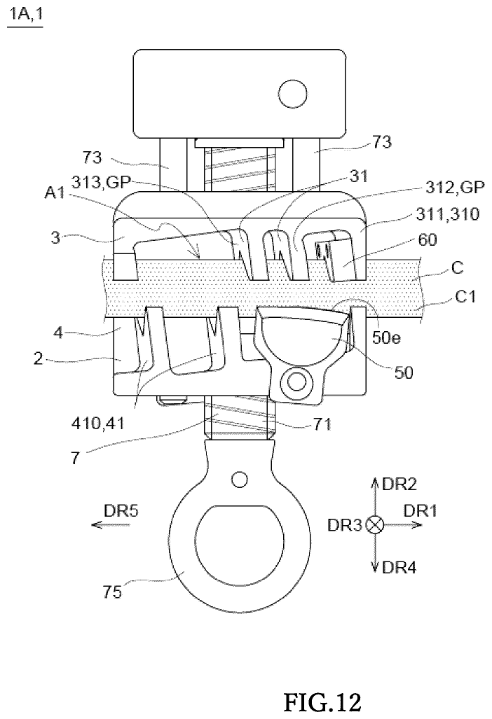

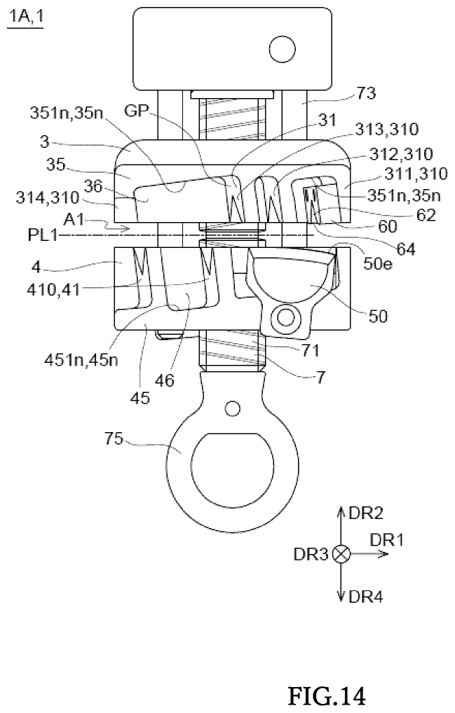

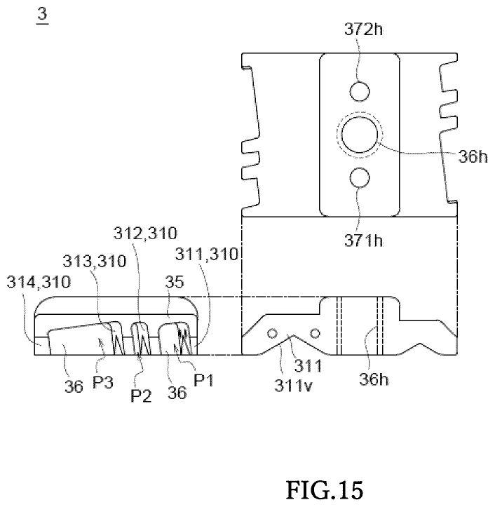

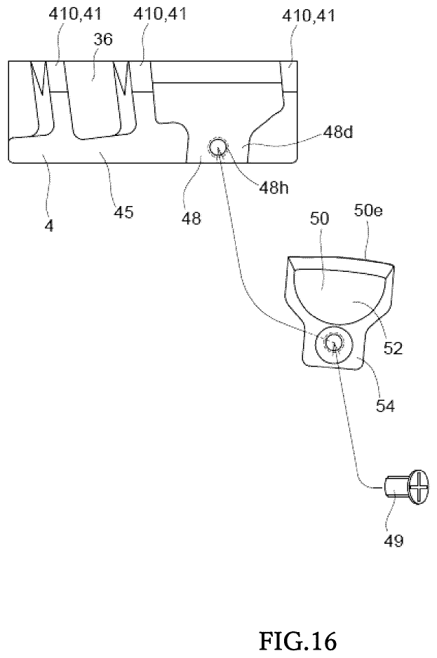

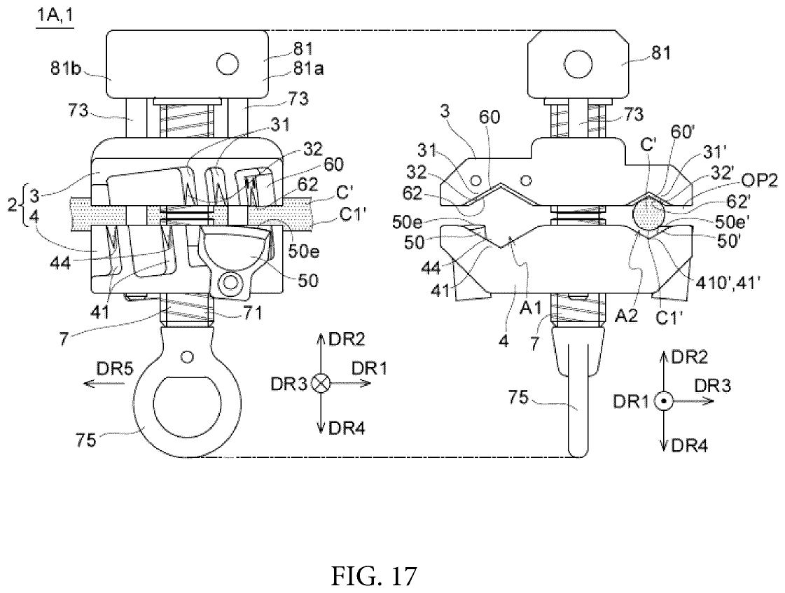

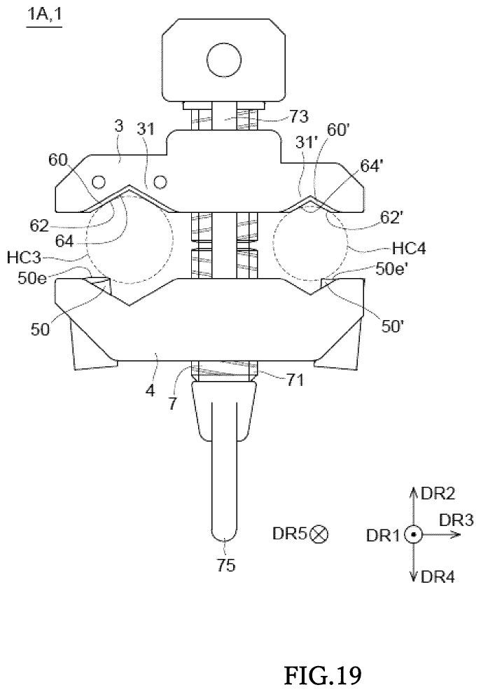

A wire stripper 1A of a first embodiment will be described with reference to FIG. 1 to FIG. 19. FIG. 1 is a schematic two-side view schematically illustrating the wire stripper 1A of the first embodiment. FIG. 2 is a schematic two-side view schematically illustrating a state after the sheathed wire C has been arranged in the wire stripper body 2 of the wire stripper 1A of the first embodiment. A schematic side view is illustrated on the left side in each of FIG. 1 and FIG. 2, and a schematic front view is illustrated on the right side in each of FIG. 1 and FIG. 2. FIG. 3 is a schematic front view schematically illustrating the wire stripper 1A of the first embodiment. FIG. 4 is a schematic front view schematically illustrating a state after the sheathed wire C has been arranged in the wire stripper body 2 of the wire stripper 1A of the first embodiment. FIG. 5 is an arrow E-E sectional view in FIG. 1. FIG. 6 is a schematic side view schematically illustrating a state after the sheathed wire C has been arranged in the wire stripper body 2 of the wire stripper 1A of the first embodiment. FIG. 7 is an enlarged schematic front view illustrating a part of the wire stripper 1A of the first embodiment. FIG. 8 is a schematic three-side view schematically illustrating an example of a press plate part 60. A schematic side view is illustrated on the upper left side in FIG. 8, a schematic front view is illustrated on the upper right side in FIG. 8, and a schematic bottom view is illustrated on the lower side in FIG. 8. FIG. 9 and FIG. 10 are arrow F-F sectional views in FIG. 1. FIG. 11 is a schematic side view schematically illustrating a situation where the press plate part 60 is attached to the first member 3. FIG. 12 is a schematic side view schematically illustrating a state after a sheathed wire C has been arranged in the wire stripper body 2 of the wire stripper 1A of the first embodiment. FIG. 13 is a schematic side view schematically illustrating a situation where stripping work on the sheathed wire C is being performed by the wire stripper 1A of the first embodiment. FIG. 14 is a schematic side view schematically illustrating the wire stripper 1A of the first embodiment. FIG. 15 is a schematic three-side view schematically illustrating an example of the first member 3. A schematic plan view is illustrated on the upper right side in FIG. 15, a schematic front view is illustrated on the lower right side in FIG. 15, and a schematic side view is illustrated on the lower left side in FIG. 15. FIG. 16 is a schematic side view schematically illustrating a situation where a blade body 50 is attached to the second member 4. FIG. 17 is a schematic two-side view schematically illustrating a state after a second sheathed wire C′ has been arranged in a wire stripper body 2 of the wire stripper 1A of the first embodiment. A schematic side view is illustrated on the left side in FIG. 17, and schematic front view is illustrated on the right side in FIG. 17. FIG. 18 and FIG. 19 are schematic front views schematically illustrating the wire stripper 1A of the first embodiment.

As illustrated in FIG. 1 as an example, the wire stripper 1A of the first embodiment has the wire stripper body 2, the blade body 50, the press plate part 60, and a distance adjusting member 7.

The wire stripper body 2 has the first member 3, the second member 4 arranged facing the first member 3, and the first passage A1 in which a part of a sheathed wire is arranged. The first passage A1 is defined by the first member 3 and the second member 4.

In the example illustrated in FIG. 2, the first member 3 has a first guide part 31. The first guide part 31 defines a part of the first passage A1. Further, the first guide part 31 guides relative motion of the wire stripper body 2 relative to the sheathed wire C.

The blade body 50 is attached to the second member 4. The blade body 50 separates the sheathed wire C into a sheath layer C1 and a core wire C2 (see FIG. 13, if necessary) when the wire stripper body 2 is relatively rotated about the sheathed wire C with respect to the sheathed wire C. Note that the sheathed wire C is, for example, an electric wire. Further, the core wire C2 is, for example, a conductor through which current flows, and the sheath layer C1 is, for example, an insulating sheath layer covering the core wire C2 that is a conductor.

The press plate part 60 is arranged on the first member 3. More specifically, as illustrated in FIG. 1 as an example, the press plate part 60 is arranged on the first member 3 so as to face the blade body 50. The press plate part 60 has a press surface 62 that presses the sheathed wire C (see FIG. 2, if necessary) against the blade body 50. In the example illustrated in FIG. 1, the press plate part 60 is attached to the first member 3. The press plate part 60 is preferably detachable from the first member 3. In such a case, the press plate part 60 can be easily replaced with another press plate part. Further, by replacing the press plate part 60 with another press plate part, it is also possible to adjust an amount of protrusion by which the press plate part 60 protrudes from the first guide part 31 in a direction toward the blade body 50. Alternatively, the press plate part 60 may be formed integrally with the first member 3.

The distance adjusting member 7 adjusts the distance between the first member 3 and the second member 4. More specifically, the distance adjusting member 7 can change the distance between the first member 3 and the second member 4 to be a distance between a first distance L1 (see FIG. 3) and a second distance L2 (see FIG. 4).

As illustrated in FIG. 3 as an example, the first distance L1 is a distance at which the sheathed wire C is allowed to be inserted into the first passage A1 from outside of the wire stripper body 2 via a first side opening OP1 between the first member 3 and the second member 4. In other words, when the distance between the first member 3 and the second member 4 is the first distance L1, the opening width W1 of the first side opening OP1 is larger than the diameter of the sheathed wire C. Further, as illustrated in FIG. 4 as an example, the second distance L2 is a distance at which the sheathed wire C is gripped between the blade body 50 and the press plate part 60. When the distance between the first member 3 and the second member 4 is the second distance L2, the opening width W2 of the first side opening OP1 is smaller than the diameter of the sheathed wire C.

In the example illustrated in FIG. 3, the distance adjusting member 7 has a threaded rod 71 screwed into at least one of the first member 3 and the second member 4 and an operating part 75 used for turning the threaded rod 71. Additionally, the distance adjusting member 7 may have a guide rod 73 for guiding relative motion of the first member 3 relative to the second member 4. In the example illustrated in FIG. 3, when the operating part 75 is operated in a first operation direction MR1, thereby the distance between the first member 3 and the second member 4 decreases. Further, when the operating part 75 is operated in a second operation direction MR2 (in other words, the direction opposite to the first operation direction MR1), thereby the distance between the first member 3 and the second member 4 expands.

As illustrated in FIG. 4 as an example, in the first embodiment, the press plate part 60 protrudes on the first passage A1 side from the first guide part 31. Thus, when the distance between the first member 3 and the second member 4 is reduced by the distance adjusting member 7, the sheathed wire C is gripped between the blade body 50 and the press plate part 60. Therefore, when the wire stripper body 2 is relatively rotated about the sheathed wire C with respect to the sheathed wire C with the sheathed wire C being gripped between the blade body 50 and the press plate part 60, thereby stripping of the sheath layer C1 by the blade body 50 is smoothly started.

As illustrated in FIG. 4 as an example, in the first embodiment, the first guide part 31 of the first member 3 is arranged at a position relatively receded from the center of the first passage A1 (or the center of the sheathed wire C arranged in the first passage A1) compared to the press plate part 60. Thus, when the sheathed wire C is gripped between the blade body 50 and the press plate part 60, the pressing force applied from the first guide part 31 of the first member 3 to the sheathed wire C is substantially zero or relatively small. In other words, due to a reduction of the distance between the first member 3 and the second member 4 (more specifically, an increase in clamping force by the threaded rod 71), the pressing force acting on the sheathed wire C from the first guide part 31 does not rapidly increase. Therefore, when the wire stripper body 2 is relatively rotated with respect to the sheathed wire C, the relative motion of the wire stripper body 2 relative to the sheathed wire C is not obstructed by the first guide part 31.

On the other hand, the first guide part 31 suppresses the sheathed wire C from excessively bending in a region inside the wire stripper body 2. Further, the first guide part 31 suppresses the wire stripper body 2 from excessively tilting with respect to the sheathed wire C.

The anti-bending function of the first guide part 31 or the anti-tilting function of the first guide part 31 will be more specifically described. In the example illustrated in FIG. 2, the sheathed wire C runs straight. Further, the sheathed wire C gripped between the blade body 50 and the press plate part 60 is spaced apart from the first guide part 31. In the example illustrated in FIG. 2, let us assume a case where the sheathed wire C is bent. In such a case, the first guide part 31 comes into contact with the bent portion of the sheathed wire C, and thereby the first guide part 31 suppresses the sheathed wire C from excessively bending in a region inside the wire stripper body 2. Further, in the example illustrated in FIG. 2, let us assume a case where the wire stripper body 2 tilts about an axis parallel to the third direction DR3 with respect to the sheathed wire C. In such a case, the first guide part 31 comes into contact with the sheathed wire C, and thereby the first guide part 31 suppresses the wire stripper body 2 from excessively tilting with respect to the sheathed wire C.

Due to the anti-bending function of the first guide part 31 or the anti-tilting function of the first guide part 31, the wire stripper body 2 can stably, relatively move with respect to the sheathed wire C. Accordingly, stripping of the sheath layer C1 by the blade body 50 is smoothly performed.

Subsequently, optional, additional configurations that can be employed in the wire stripper 1A of the first embodiment will be described with reference to FIG. 1 to FIG. 19.

### Auxiliary Guide Part 41

In the example illustrated in FIG. 2, the second member 4 has an auxiliary guide part 41. The auxiliary guide part 41 defines a part of the first passage A1. Further, the auxiliary guide part 41 guides relative motion of the wire stripper body 2 relative to the sheathed wire C.

In the example illustrated in FIG. 4, the blade body 50 protrudes on the first passage A1 side from the auxiliary guide part 41. In such a case, the auxiliary guide part 41 does not substantially press the sheathed wire C. In other words, due to a reduction of the distance between the first member 3 and the second member 4 (more specifically, an increase in clamping force by the threaded rod 71), the pressing force acting on the sheathed wire C from the auxiliary guide part 41 does not rapidly increase. Therefore, when the wire stripper body 2 is relatively rotated with respect to the sheathed wire C, the relative motion of the wire stripper body 2 relative to the sheathed wire C is not obstructed by the auxiliary guide part 41.

On the other hand, the auxiliary guide part 41 suppresses the sheathed wire C from excessively bending in a region inside the wire stripper body 2. Further, the auxiliary guide part 41 suppresses the wire stripper body 2 from excessively tilting with respect to the sheathed wire C.

The anti-bending function of the auxiliary guide part 41 or the anti-tilting function of the auxiliary guide part 41 will be more specifically described. In the example illustrated in FIG. 2, the sheathed wire C runs straight. Further, the sheathed wire C gripped between the blade body 50 and the press plate part 60 is spaced apart from the auxiliary guide part 41. In the example illustrated in FIG. 2, let us assume a case where the sheathed wire C is bent. In such a case, the auxiliary guide part 41 comes into contact with the bent portion of the sheathed wire C, and thereby the auxiliary guide part 41 suppresses the sheathed wire C from excessively bending in a region inside the wire stripper body 2. Further, in the example illustrated in FIG. 2, let us assume a case where the wire stripper body 2 tilts about an axis parallel to the third direction DR3 with respect to the sheathed wire C. In such a case, the auxiliary guide part 41 comes into contact with the sheathed wire C, and thereby the auxiliary guide part 41 suppresses the wire stripper body 2 from excessively tilting with respect to the sheathed wire C.

Note that, when neither excessive bending of the sheathed wire C nor excessive tilting of the wire stripper body 2 occurs, the auxiliary guide part 41 may be omitted.

In the example illustrated in FIG. 2, the auxiliary guide part 41 includes at least one plate part 410. The number of plate parts 410 of the auxiliary guide part 41 may be one, two, three, or four or greater. In the example illustrated in FIG. 5, the auxiliary guide part 41 includes two plate parts 410a, 410b arranged interposing the blade body 50 therebetween in the direction along the first direction DR1. In such a case, the blade body 50 is protected by the two plate parts 410a, 410b. Further, the two plate parts 410a, 410b prevent an operator's finger from unintentionally touching the blade body 50.

In the example illustrated in FIG. 6, at least one plate part 410 of the auxiliary guide part 41 is inclined with respect to a surface perpendicular to the first passage A1. Alternatively, at least one plate part 410 or all the plate parts 410 may be parallel to the surface perpendicular to the first passage A1.

In the example illustrated in FIG. 6, the auxiliary guide part 41 (more specifically, each plate part 410) has a recess 44 that can receive a part of the sheathed wire C. The recess 44 is, for example, a V-shaped recess. When the recess 44 is a V-shaped recess, the recess 44 can suitably receive a part of any sheathed wire C having a diameter within a predetermined range. Note that, in the present specification, “V-shape” encompasses an approximate V-shape. For example, although the angle of the bottom vertex angle of the V-shape is smaller than 90 degrees in a strict sense, the “V-shape” in the present specification encompasses a form in which the angle of the bottom vertex angle of the V-shape is 90 degrees or larger than 90 degrees. Further, the bottom vertex angle of the V-shape may be rounded.

### Positional Relationship Between Press Plate Part 60, First Guide Part 31, and Auxiliary Guide Part 41

In the example illustrated in FIG. 7, when viewed in a direction along the first passage A1 (more specifically, when viewed in a direction along the fifth direction DR5), the diameter of a first virtual circular cylinder HC1 inscribed in both the press plate part 60 and the auxiliary guide part 41 is smaller than the diameter of a second virtual circular cylinder HC2 inscribed in both the first guide part 31 and the auxiliary guide part 41. In such a case, even when the distance between the first member 3 and the second member 4 is reduced such that the blade body 50 bites into the sheathed wire C to the maximum extent possible (in such a case, the first virtual circular cylinder HC1 corresponds to the outer circumferential surface of the sheathed wire C), the pressing force acting on the sheathed wire C from the first guide part 31 of the first member 3 is substantially zero or small.

### Press Plate Part 60

In the example illustrated in FIG. 7, when viewed in a direction along the first passage A1 (more specifically, when viewed in a direction along the fifth direction DR5), the press surface 62 of the press plate part 60 has a V-shape (a V-shape having the bottom vertex angle on the second direction DR2 side). In such a case, any sheathed wire C having a diameter within a predetermined range (in other words, any sheathed wire C having a diameter larger than or equal to a first threshold TH1 and smaller than or equal to a second threshold TH2) is suitably gripped between the press surface 62 of the press plate part 60 and the blade body 50. More specifically, any sheathed wire C having a diameter within a predetermined range is stably gripped by two slope surfaces forming the V-shape and by the blade body 50. Note that the first threshold TH1 and the second threshold TH2 described above can be suitably changed by adjusting the size, the shape, or the arrangement of the press plate part 60, the size, the shape, or the arrangement of the blade body 50, or the like.

In the example illustrated in FIG. 8, the press plate part 60 has a V-shaped groove 64 defining the press surface 62 that presses the sheathed wire C. In other words, the surface of the V-shaped groove 64 is the press surface 62 that presses the sheathed wire C. In the example illustrated in FIG. 8 and FIG. 9, the V-shaped groove 64 of the press plate part 60 extends in a direction along the first direction DR1.

In the example illustrated in FIG. 9, when viewed in a direction along the second direction DR2, the press plate part 60 is inclined with respect to the third direction DR3. Because the press plate part 60 is inclined with respect to the third direction DR3, when the wire stripper body 2 is relatively rotated about the sheathed wire C with respect to the sheathed wire C, the press plate part 60 applies, to the wire stripper body 2, driving force on the sheathed wire C in the fifth direction DR5 (in other words, the direction opposite to the first direction DR1). Accordingly, stripping of the sheath layer C1 from the core wire C2 proceeds in a helical manner (see FIG. 13).

The width dimension, the height dimension, and the thickness dimension of the press plate part 60 are not particularly limited. In the example illustrated in FIG. 8, the width dimension W of the press plate part 60 is larger than the height dimension H of the press plate part 60. Further, the width dimension W of the press plate part 60 is larger than the thickness dimension T of the press plate part 60.

In the example illustrated in FIG. 8, the press plate part 60 has attaching holes 60h in which a fastening member such as a fastening screw is inserted. For example, each attaching hole 60h extends along a direction generally parallel to the thickness direction of the press plate part 60. In the example illustrated in FIG. 8, the number of attaching holes 60h of the press plate part 60 is two. Alternatively, the number of attaching holes 60h of the press plate part 60 may be one or three or greater.

### First Guide Part 31

In the example illustrated in FIG. 9, the first guide part 31 (more specifically, a guide plate 310 described later) of the first member 3 has a guide surface 32 that can come into contact with the sheathed wire C. In the example illustrated in FIG. 7, when viewed in a direction along the first passage A1 (more specifically, when viewed in a direction along the fifth direction DR5), the guide surface 32 of the first guide part 31 has a V-shape (a V-shape having the bottom vertex angle on the second direction DR2 side). In such a case, the guide surface 32 can suitably guide any sheathed wire C having a diameter within a predetermined range.

In the example illustrated in FIG. 9, the first guide part 31 of the first member 3 includes guide plates 310 that guide the sheathed wire C. The number of guide plates 310 of the first guide part 31 may be one, two, three, or four or greater. Note that the plate thickness of each guide plate 310 is not particularly limited. Some types of sheathed wire C may have a fin part formed longitudinally on the outer circumferential surface of the sheathed wire C. When the plate thickness of each guide plate 310 is thin, this can cause only a small rotation resistance received by each guide plate 310 from the fin part when the wire stripper body 2 is relatively rotated with respect to the sheathed wire C.

In the example illustrated in FIG. 9, each of the plurality of guide plates 310 has a V-shaped guide groove 310v. More specifically, each of the plurality of guide plates 310 has the V-shaped guide groove 310v defining the guide surface 32 that guides the sheathed wire C. In other words, the surface of the V-shaped guide groove 310v is the guide surface 32 that guides the sheathed wire C. In the example illustrated in FIG. 9, the guide groove 310v extends in a direction along the first passage A1 (in other words, extends in a direction along the first direction DR1). Further, in the example illustrated in FIG. 9, the plurality of guide grooves 310v of the first guide part 31 are aligned in a straight line along the first direction DR1.

In the example illustrated in FIG. 10, the first guide part 31 includes a first guide plate 311 and a second guide plate 312 arranged interposing the press plate part 60 therebetween in a direction along the first direction DR1. Additionally, the first guide part 31 may include a third guide plate 313 and/or a fourth guide plate 314.

In the example illustrated in FIG. 10, the first guide plate 311 has a V-shaped first guide groove 311v, and the second guide plate 312 has a V-shaped second guide groove 312v. Further, the third guide plate 313 has a V-shaped third guide groove 313v, and the fourth guide plate 314 has a V-shaped fourth guide groove 314v.

In the example illustrated in FIG. 10, the first guide part 31 has an inclined guide plate GP that assists helical movement of the wire stripper body 2 relative to the sheathed wire C. More specifically, the first guide part 31 has the inclined guide plate GP inclined with respect to the third direction DR3 when viewed in a direction along the second direction DR2. The inclined guide plate GP is inclined with respect to the third direction DR3 so as to correspond to a part of a helix of right-hand thread (or left-hand thread).

The first guide part 31 may have two or more inclined guide plates GP that assist the helical movement of the wire stripper body 2 relative to the sheathed wire C. In the example illustrated in FIG. 12, each of the second guide plate 312 and the third guide plate 313 is the inclined guide plate GP.

In the example illustrated in FIG. 13, let us assume a case where the wire stripper body 2 is relatively rotated about the sheathed wire C with respect to the sheathed wire C. In such a case, the sheath layer C1 of the sheathed wire C is stripped by the blade body 50. When stripping of the sheath layer C1 from the sheathed wire C proceeds, the press plate part 60 faces the exposed core wire C2. Therefore, the pressing force with which the press plate part 60 presses the sheathed wire C is reduced or becomes substantially zero. Then, when the wire stripper body 2 is relatively rotated about the sheathed wire C with respect to the sheathed wire C, the inclined guide plate GP comes into contact with the sheathed wire C. The inclined guide plate GP in contact with the sheathed wire C applies, to the wire stripper body 2, driving force on the sheathed wire C in the fifth direction DR5 (in other words, the direction opposite to the first direction DR1). Accordingly, stripping of the sheath layer C1 from the core wire C2 proceeds in a helical manner.

Note that, when the blade body 50 applies, to the wire stripper body 2, sufficient driving force on the sheathed wire C in the fifth direction DR5 (in other words, the direction opposite to the first direction DR1), otherwise, when such driving force is applied by the user's hand, or the like, it is not necessarily required for the first guide part 31 described above to apply the driving force on the sheathed wire C to the wire stripper body 2. In such a case, all the guide plates 310 of the first guide part 31 may not be the inclined guide plates. In other words, all the guide plates 310 of the first guide part 31 may be parallel to the third direction DR3.

In the example illustrated in FIG. 10 and FIG. 11, when viewed in a direction along the second direction DR2, the inclined guide plate GP is inclined with respect to the third direction DR3 (see FIG. 10), and when viewed in a direction along the third direction DR3, the inclined guide plate GP is inclined with respect to the second direction DR2 (see FIG. 11). These inclinations effectively assist the helical movement of the wire stripper body 2 relative to the sheathed wire C.

In the example illustrated in FIG. 11, the first guide plate 311 has holes 311h in which fastening members 68 such as fastening screws are inserted. Each fastening member 68 is inserted in both the hole 311h of the first guide plate 311 and the attaching hole 60h of the press plate part 60, and thereby the press plate part 60 is fixed to the first guide plate 311.

In the example illustrated in FIG. 10, the plate thickness of the first guide plate 311 increases toward the third direction DR3. Further, in the example illustrated in FIG. 11, the plate thickness of the first guide plate 311 increases toward the second direction DR2.

In the example illustrated in FIG. 10, the first guide part 31 has the first guide plate 311 arranged at the end on the first direction DR1 side of the first member 3 and the fourth guide plate 314 arranged at the end on the fifth direction DR5 side of the first member 3. In the example illustrated in FIG. 10, the plate thickness of the fourth guide plate 314 decreases toward the third direction DR3. Further, in the example illustrated in FIG. 11, the plate thickness of the fourth guide plate 314 decreases toward the second direction DR2.

### First Member 3

In the example illustrated in FIG. 14, the first member 3 has a first guide part 31 (more specifically, at least one guide plate 310), a first block part 36, and a top wall 35.

In the example illustrated in FIG. 9, the first block part 36 extends in the first direction DR1. The first block part 36 has a first threaded hole 36h screwed onto the threaded rod 71 and a guide hole 371h in which a first guide rod 73a is inserted. Additionally, the first block part 36 may have a second guide hole 372h in which a second guide rod 73b is inserted. In the example illustrated in FIG. 9, the first threaded hole 36h is arranged in the center portion of the first block part 36. Further, the first threaded hole 36h is arranged between the guide hole 371h and the second guide hole 372h.

In the example illustrated in FIG. 14, the top wall 35 supports the first guide part 31 (more specifically, at least one guide plate 310). Further, the top wall 35 extends in a direction along the first passage A1.

In the example illustrated in FIG. 14, the inner surface 35n of the top wall 35 is inclined with respect to a plane PL1 perpendicular to the second direction DR2. More specifically, the inner surface 35n of the top wall 35 is inclined with respect to the first passage A1 so as to be substantially perpendicular to the inclined guide plate GP.

When the inner surface 35n of the top wall 35 is an inclined surface 351n inclined with respect to the plane PL1 perpendicular to the second direction DR2 (more specifically, when the inner surface 35n of the top wall 35 is substantially perpendicular to the inclined guide plate GP), the inclined guide plate GP and the top wall 35 inclined with respect to the first passage A1 can be easily formed integrally. More specifically, the inclined guide plate GP and the top wall 35 can be easily formed by casting and/or cutting.

In the example illustrated in FIG. 15, a first pocket P1 is defined by the first guide plate 311, the second guide plate 312, the first block part 36, and the top wall 35. The press plate part 60 is arranged in the first pocket P1 (see FIG. 11, if necessary).

As illustrated in FIG. 15 as an example, a second pocket P2 may be defined by the second guide plate 312, the third guide plate 313, the first block part 36, and the top wall 35. Further, a third pocket P3 may be defined by the third guide plate 313, the fourth guide plate 314, the first block part 36, and the top wall 35.

The pockets (P1, P2, P3) described above separate one guide plate 310 of the first guide part 31 from another guide plate 310 of the first guide part 31.

### Second Member 4

In the example illustrated in FIG. 5, the second member 4 has an auxiliary guide part 41 (more specifically, at least one plate part 410), a second block part 46, and a top wall 45.

In the example illustrated in FIG. 5, the second block part 46 extends in the first direction DR1. The second block part 46 has a second threaded hole 46h screwed onto the threaded rod 71 and a guide hole 471h in which the first guide rod 73a is inserted. Additionally, the second block part 46 may have a second guide hole 472h in which the second guide rod 73b is inserted. In the example illustrated in FIG. 5, the second threaded hole 46h is arranged in the center portion of the second block part 46. Further, the second threaded hole 46h is arranged between the guide hole 471h and the second guide hole 472h.

In the example illustrated in FIG. 14, the top wall 45 supports the auxiliary guide part 41 (more specifically, at least one plate part 410). Further, the top wall 45 extends in a direction along the first passage A1.

In the example illustrated in FIG. 14, the inner surface 45n of the top wall 45 is inclined with respect to the plane PL1 perpendicular to the second direction DR2. More specifically, the inner surface 45n of the top wall 45 has an inclined surface 451n inclined closer to the first passage A1 toward the first direction DR1. The inner surface 45n of the top wall 45 (more specifically, the inclined surface 451n) may be substantially perpendicular to the plate part 410 of the auxiliary guide part 41.

In the example illustrated in FIG. 16, an attachment receiving part 48 to which an attaching part 54 of the blade body 50 is attached is formed to the second member 4 (more specifically, the top wall 45 of the second member 4). The attachment receiving part 48 may have a recess 48d to receive the attaching part 54. Alternatively or additionally, the attachment receiving part 48 may have a hole 48h (for example, a threaded hole) in which a fastening member 49 such as a fastening screw is inserted.

### Blade Body 50

In the example illustrated in FIG. 16, the blade body 50 has a blade edge 50e, a scoop part 52 for scooping a sheath layer of a sheathed wire, and an attaching part 54. The attaching part 54 is attached to the second member 4 (more specifically, the attachment receiving part 48 of the second member 4) via the fastening member 49 such as a fastening screw. In the example illustrated in FIG. 16, the blade body 50 has a shape corresponding to a part of a spherical shell, and the blade body 50 functions as a scooping blade for scooping up the sheath layer C1 of the sheathed wire C.

In the example illustrated in FIG. 13, the blade edge 50e of the blade body 50 is inclined away from the first passage A1 toward the first direction DR1. In such a case, when the wire stripper body 2 is relatively rotated about the sheathed wire C with respect to the sheathed wire C, the blade edge 50e of the blade body 50 strips the sheath layer C1 from the sheathed wire C and applies, to the wire stripper body 2, driving force on the sheathed wire C in the fifth direction DR5 (in other words, the direction opposite to the first direction DR1).

In the example illustrated in FIG. 5, when viewed in a direction along the fourth direction DR4, the blade edge 50e of the blade body 50 has a substantially circular-arc shape. More specifically, when viewed in a direction along the fourth direction DR4, the blade edge 50e has a substantially circular-arc shape convex toward the first passage A1. In such a case, the blade body 50 can suitably strip the sheath layer C1 from any sheathed wire C having a diameter within a predetermined range (in other words, any sheathed wire C having a diameter larger than or equal to a first threshold TH1 and smaller than or equal to a second threshold TH2).

### Distance Adjusting Member 7

In the example illustrated in FIG. 3, the distance adjusting member 7 has the threaded rod 71, the guide rod 73, and the operating part 75.

In the example illustrated in FIG. 3, the threaded rod 71 is screwed into both the first member 3 and the second member 4, and the guide rod 73 is inserted in both the first member 3 and the second member 4. The guide rod 73 guides the relative motion of the first member 3 relative to the second member 4. Further, the operating part 75 is mechanically connected to the threaded rod 71 and relatively rotates the threaded rod 71 with respect to both the first member 3 and the second member 4.

In the example illustrated in FIG. 3, the operating part 75 is operated in the first operation direction MR1, and thereby the threaded rod 71 is turned in the same direction as the first operation direction MR1, and the distance between the first member 3 and the second member 4 is reduced. Further, the operating part 75 is operated in the second operation direction MR2, and thereby the threaded rod 71 is turned in the same direction as the second operation direction MR2, and the distance between the first member 3 and the second member 4 is expanded.

An example of the distance adjusting member 7 will be described in more detail. In the example illustrated in FIG. 4, the threaded rod 71 is screwed into both the first member 3 and the second member 4. More specifically, the threaded rod 71 has a threaded part 71a screwed into the first member 3 and a reverse threaded part 71b screwed into the second member 4. In such a case, when the threaded rod 71 is turned in the first rotation direction about the central axis of the threaded rod, the first member 3 and the second member 4 are moved closer to each other. In such a way, the distance between the first member 3 and the second member 4 is reduced. Further, when the threaded rod 71 is turned in the second rotation direction about the central axis of the threaded rod, the first member 3 and the second member 4 are moved away from each other. In such a way, the distance between the first member 3 and the second member 4 is expanded.

In the example illustrated in FIG. 2, the wire stripper 1A has a support block 81 that rotatably support the threaded rod 71. Further, the operating part 75 is attached to the threaded rod 71 on the opposite side from the side on which the support block 81 is arranged.

In the example illustrated in FIG. 2, the guide rod 73 includes a first guide rod 73a and a second guide rod 73b. Each of the first guide rod 73a and the second guide rod 73b is inserted in the guide hole (371h, 372h) formed in the first member 3 so as to be slidable with respect to the first member 3 (see FIG. 9, if necessary). Further, each of the first guide rod 73a and the second guide rod 73b is inserted in the guide hole (471h, 472h) formed in the second member 4 so as to be slidable with respect to the second member 4 (see FIG. 5, if necessary).

In the example illustrated in FIG. 2, the guide rod 73 is fixed to the support block 81. Alternatively, the guide rod 73 may be fixed to the first member 3 or the second member 4. In such a case, the guide rod 73 is configured to be slidable with respect to only one of the first member 3 and the second member 4.

In the example illustrated in FIG. 2, the operating part 75 includes an operating ring 750. The operating ring 750 can be operated by a remote operation tool. More specifically, with a hook part of the remote operation tool being inserted in the operating ring 750, this hook part is rotated, and thereby the operating ring 750 is operated.

### Structure of Stripping Second Sheath Layer C1′ From Second Sheathed Wire C′

As illustrated in FIG. 17 as an example, the wire stripper 1A of the first embodiment may have a structure that can strip a second sheath layer C1′ from a second sheathed wire C′ that is thinner than the sheathed wire C. An example of the structure that can strip the second sheath layer C1′ from the second sheathed wire C′ will be described below.

The wire stripper 1A has a second blade body 50′ and a second press plate part 60′ in addition to the wire stripper body 2, the blade body 50, the press plate part 60, and the distance adjusting member 7.

The wire stripper body 2 has, in addition to the first passage A1, a second passage A2 in which a part of the second sheathed wire C′ is arranged. The second passage A2 is defined by the first member 3 and the second member 4. In the example illustrated in FIG. 17, the second passage A2 is parallel to the first passage A1.

The second blade body 50′ is attached to one of the first member 3 and the second member 4. In the example illustrated in FIG. 17, the second blade body 50′ is attached to the second member 4. The wire stripper body 2 is relatively rotated with respect to the second sheathed wire C′, and thereby the second blade body 50′ separates the second sheathed wire C′ into a second sheath layer C1′ and a second core wire.

The second press plate part 60′ is arranged to the other of the first member 3 and the second member 4 so as to face the second blade body 50′. In the example illustrated in FIG. 17, the second press plate part 60′ is arranged to the first member 3. The second press plate part 60′ has a second press surface 62′ that presses the second sheathed wire C′ against the second blade body 50′.

A second guide part 31′ is arranged to the other of the first member 3 and the second member 4 so as to define a part of the second passage A2. In the example illustrated in FIG. 17, the second guide part 31′ is arranged to the first member 3. The second guide part 31′ guides relative motion of the wire stripper body 2 relative to the second sheathed wire C′.

In the example illustrated in FIG. 18, the second press plate part 60′ protrudes on the second passage A2 side from the second guide part 31′. Thus, when the distance between the first member 3 and the second member 4 is reduced by the distance adjusting member 7, the second sheathed wire C′ is gripped between the second blade body 50′ and the second press plate part 60′. Therefore, the wire stripper body 2 is relatively rotated about the second sheathed wire C′ with respect to the second sheathed wire C′ with the second sheathed wire C′ being gripped between the second blade body 50′ and the second press plate part 60′, and thereby the stripping of the second sheath layer C1′ by the second blade body 50′ is smoothly started.

The second guide part 31′ is arranged at a position relatively receded from the center of the second passage A2 (or the center of the second sheathed wire C′ arranged in the second passage A2) compared to the second press plate part 60′. Thus, when the second sheathed wire C′ is gripped between the second blade body 50′ and the second press plate part 60′, the pressing force applied from the second guide part 31′ to the second sheathed wire C′ is substantially zero or relatively small. In other words, due to a reduction of the distance between the first member 3 and the second member 4 (more specifically, an increase in clamping force by the threaded rod 71), the pressing force acting on the second sheathed wire C′ from the second guide part 31′ does not rapidly increase. Therefore, when the wire stripper body 2 is relatively rotated with respect to the second sheathed wire C′, the relative motion of the wire stripper body 2 relative to the second sheathed wire C′ is not obstructed by the second guide part 31′.

On the other hand, the second guide part 31′ suppresses the second sheathed wire C′ from excessively bending in a region inside the wire stripper body 2. Further, the second guide part 31′ suppresses the wire stripper body 2 from excessively tilting with respect to the second sheathed wire C′.

In the example illustrated in FIG. 18, the second blade body 50′ is arranged to the second member 4, and the second press plate part 60′ and the second guide part 31′ are arranged to the first member 3. Alternatively, the second blade body 50′ may be arranged to the first member 3, and the second press plate part 60′ and the second guide part 31′ may be arranged to the second member 4.

### Distance Adjusting Member 7

The distance adjusting member 7 adjusts the distance between the first member 3 and the second member 4. More specifically, the distance adjusting member 7 can change the distance between the first member 3 and the second member 4 to be a distance between a third distance L3 and a fourth distance L4.

As illustrated in FIG. 18 as an example, the third distance L3 is a distance at which the second sheathed wire C′ is allowed to be inserted into the second passage A2 from outside of the wire stripper body 2 via a second side opening OP2 between the first member 3 and the second member 4. In other words, when the distance between the first member 3 and the second member 4 is the third distance L3, the opening width W3 of the second side opening OP2 is larger than the diameter of the second sheathed wire C′. Further, as illustrated in FIG. 17 as an example, the fourth distance is a distance at which the second sheathed wire C′ is gripped between the second blade body 50′ and the second press plate part 60′. When the distance between the first member 3 and the second member 4 is the fourth distance, the opening width of the second side opening OP2 is smaller than the diameter of the second sheathed wire C′.

### Second Auxiliary Guide Part 41′

As illustrated in FIG. 17 as an example, in addition to the second blade body 50′, a second auxiliary guide part 41′ may be arranged to one of the first member 3 and the second member 4. The second auxiliary guide part 41′ defines a part of the second passage A2 and guides the relative motion of the wire stripper body 2 relative to the second sheathed wire C′. The second auxiliary guide part 41′ may include at least one plate part 410′.

The action provided by the second auxiliary guide part 41′ (or the plate part 410′) on the second sheathed wire C′ is the same as the action provided by the auxiliary guide part 41 (or the plate part 410) on the sheathed wire C. Thus, for the second auxiliary guide part 41′ (or the plate part 410′), the description for the auxiliary guide part 41 (or the plate part 410) is quoted, and the duplicated description for the second auxiliary guide part 41′ (or the plate part 410′) will be omitted.

### Second Press Plate Part 60′

In the example illustrated in FIG. 18, when viewed in a direction along the second passage A2, a second press surface 62′ of the second press plate part 60′ has a V-shape. In the example illustrated in FIG. 18, the second press plate part 60′ has a V-shaped groove 64′ defining the second press surface 62′ that presses the second sheathed wire C′. In other words, the surface of the V-shaped groove 64′ is the second press surface 62′ that presses the second sheathed wire C′. The V-shaped groove 64′ of the second press plate part 60′ extends in a direction along the second passage A2.

In the example illustrated in FIG. 19, the diameter of a second virtual inscribed circle HC4 in contact with two slope surfaces of the V-shaped groove 64′ and the second blade body 50′ is smaller than the diameter of first virtual inscribed circle HC3 in contact with two slope surfaces of the V-shaped groove 64 and the blade body 50. Therefore, the second press plate part 60′ can suitably press the second sheathed wire C′, which is thinner than the sheathed wire C, against the second blade body 50′.

In the example illustrated in FIG. 9, when viewed in a direction along the second direction DR2, the second press plate part 60′ is inclined with respect to the third direction DR3. Because the second press plate part 60′ is inclined with respect to the third direction DR3, when the wire stripper body 2 is relatively rotated about the second sheathed wire C′ with respect to the second sheathed wire C′, the second press plate part 60′ applies, to the wire stripper body 2, driving force on the second sheathed wire C′ in the direction along the second passage A2 (the first direction DR1 in the example illustrated in FIG. 9). Accordingly, stripping of the second sheath layer C1′ from the second core wire proceeds in a helical manner.

In the example illustrated in FIG. 9, the second press plate part 60′ is arranged at a position that is substantially point-symmetrical from the press plate part 60 about the threaded rod 71 as the center. However, the arrangement of the second press plate part 60′ relative to the press plate part 60 is not limited to the example illustrated in FIG. 9.

### Second Guide Part 31′

In the example illustrated in FIG. 9, the second guide part 31′ (more specifically, a guide plate 310′ described later) has a guide surface 32′ that can come into contact with the second sheathed wire C′. In the example illustrated in FIG. 18, the guide surface 32′ of the second guide part 31′ has a V-shape when viewed in a direction along the second passage A2.

In the example illustrated in FIG. 18, the size of the V-shaped guide surface 32′ is smaller than the size of the V-shaped guide surface 32. Therefore, the guide surface 32′ of the second guide part 31′ can suitably guide the relative motion of the wire stripper body 2 relative to the second sheathed wire C′, which is thinner than the sheathed wire C.

In the example illustrated in FIG. 9, the second guide part 31′ includes the guide plate 310′. The number of guide plates 310′ of the second guide part 31′ may be one, two, three, or four or greater.

In the example illustrated in FIG. 9, each of the plurality of guide plates 310′ has a V-shaped guide groove 310v′. In the example illustrated in FIG. 9, each guide groove 310v′ extends in the direction along the second passage A2. Further, in the example illustrated in FIG. 9, the plurality of guide grooves 310v′ of the second guide part 31′ are aligned in a straight line along the direction in which the second passage A2 extends.

In the example illustrated in FIG. 10, the second guide part 31′ has an inclined guide plate GP′ that assists helical movement of the wire stripper body 2 relative to the second sheathed wire C′. More specifically, the second guide part 31′ has the inclined guide plate GP′ inclined with respect to the third direction DR3 when viewed in a direction along the second direction DR2. The inclined guide plate GP′ is inclined with respect to the third direction DR3 so as to correspond to a part of a helix of right-hand thread (or left-hand thread).

### First Member 3

In the example illustrated in FIG. 9, the first member 3 has the second guide part 31′ (more specifically, at least one guide plate 310′) and a second top wall 35′.

In the example illustrated in FIG. 9, the second top wall 35′ supports the second guide part 31′ (more specifically, at least one guide plate 310′). Further, the second top wall 35′ extends in a direction along the second passage A2. In the example illustrated in FIG. 9, the second top wall 35′ and the top wall 35 are partitioned from each other by the first block part 36.

### Second Member 4

In the example illustrated in FIG. 5, the second member 4 has the second auxiliary guide part 41′ (more specifically, at least one plate part 410′) and a second top wall 45′.

In the example illustrated in FIG. 5, the second top wall 45′ supports the second auxiliary guide part 41′ (more specifically, at least one plate part 410′). Further, the second top wall 45′ extends in a direction along the second passage A2. In the example illustrated in FIG. 5, the second top wall 45′ and the top wall 45 are partitioned from each other by the second block part 46.

### Second Blade Body 50′

In the example illustrated in FIG. 5, the second blade body 50′ has a second blade edge 50e′ and a second scoop part 52′ for scooping a second sheath layer of the second sheathed wire. In the example illustrated in FIG. 5, the second blade body 50′ has a shape corresponding to a part of a spherical shell, and the second blade body 50′ functions as a scooping blade for scooping up the second sheath layer of the second sheathed wire C′.

In the example illustrated in FIG. 5, the size and the shape of the second blade body 50′ are the same as the size and the shape of the blade body 50. In such a case, the manufacturing cost of the wire stripper 1A having the blade body 50 and the second blade body 50′ is reduced. Alternatively, the size of the second blade body 50′ may be smaller than the size of the blade body 50. Further, the shape of the second blade body 50′ may differ from the shape of the blade body 50.

### Second Embodiment

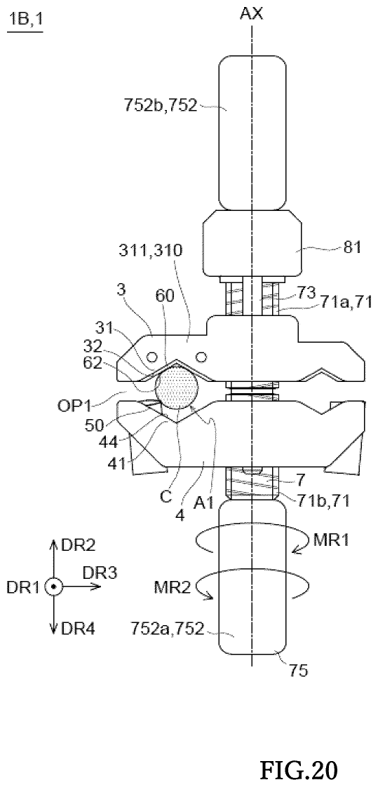

A wire stripper 1B of a second embodiment will be described with reference to FIG. 20. FIG. 20 is a schematic front view schematically illustrating the wire stripper 1B of the second embodiment.

The wire stripper 1B of the second embodiment differs from the wire stripper 1A of the first embodiment in that the operating part 75 has a handle 752 (more specifically, a rod-like handle 752) instead of the operating ring 750. The second embodiment is the same as the first embodiment in other features.

In the second embodiment, features different from those of the first embodiment will be mainly described, and the duplicated description for the features that have already been described in the first embodiment will be omitted. It is therefore apparent that the features that have already been described in the first embodiment can be employed in the second embodiment even without being explicitly described in the second embodiment.

In the example illustrated in FIG. 20, the operating part 75 has a first operating handle 752a and a second operating handle 752b. The first operating handle 752a is arranged on one end side of the threaded rod 71, and the second operating handle 752b is arranged on the other end side of the threaded rod 71.

In the example illustrated in FIG. 20, the first operating handle 752a is fixed to the threaded rod 71 so as to be non-rotatable about the central axis AX of the threaded rod 71. Further, the second operating handle 752b is attached to the threaded rod 71 so as to be rotatable about the central axis AX of the threaded rod 71. More specifically, the second operating handle 752b is attached to a support block 81 that rotatably supports the threaded rod 71 about the central axis AX of the threaded rod 71.

In the example illustrated in FIG. 20, when the first operating handle 752a is turned and operated in the first operation direction MR1 about the central axis AX of the threaded rod 71 with respect to the second operating handle 752b, the distance between the first member 3 and the second member 4 is reduced. In contrast, when the first operating handle 752a is turned and operated in the second operation direction MR2 about the central axis AX of the threaded rod 71 with respect to the second operating handle 752b, the distance between the first member 3 and the second member 4 is expanded.

The wire stripper 1B of the second embodiment is the same as the wire stripper 1A of the first embodiment for features other than the operating part 75. Thus, the second embodiment achieves the same advantageous effect of the first embodiment.

### Third Embodiment

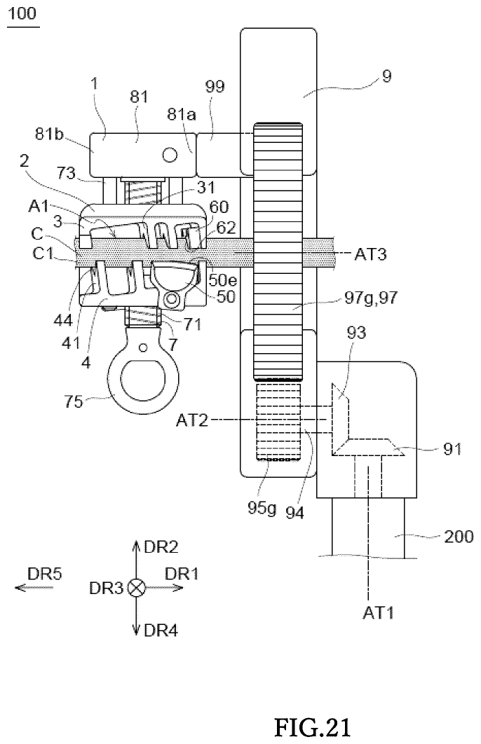

A wire stripping device 100 of a third embodiment will be described with reference to FIG. 21. FIG. 21 is a schematic side view schematically illustrating the wire stripping device 100 of the third embodiment.

As illustrated in FIG. 21 as an example, the wire stripping device 100 of the third embodiment has a wire stripper 1 and a drive force transmission device 9.

In the example illustrated in FIG. 21, the wire stripper 1 has (1) the wire stripper body 2 having the first member 3, the second member 4 arranged facing the first member 3, and the first passage A1 defined by the first member 3 and the second member 4 and configured to receive a part of the sheathed wire C to be arranged, (2) the blade body 50 attached to the second member 4 and configured to separate the sheathed wire C into the sheath layer C1 and the core wire when the wire stripper body 2 is relatively rotated with respect to the sheathed wire C, (3) the press plate part 60 arranged to the first member 3 so as to face the blade body 50 and having the press surface 62 configured to press the sheathed wire C against the blade body 50, and (4) the distance adjusting member 7 configured to adjust the distance between the first member 3 and the second member 4. (5) The first member 3 has the first guide part 31 defining a part of the first passage A1 and configured to guide relative motion of the wire stripper body 2 relative to the sheathed wire C. (6) The press plate part 60 protrudes on the first passage A1 side from the first guide part 31.

The wire stripper 1 may be the wire stripper 1A of the first embodiment, may be the wire stripper 1B of the second embodiment, or may be other wire strippers. Since the wire stripper 1 has already been described in the first embodiment and the second embodiment, the duplicated description for the wire stripper 1 will be omitted.

In the example illustrated in FIG. 21, the drive force transmission device 9 has a rotating body 97 and an attaching part 99 for attaching the wire stripper 1 to the rotating body 97. The drive force transmission device 9 converts external drive force (for example, drive force from the remote operating rod 200 or drive force from a motor) into rotary movement of the rotating body 97 about a rotation axis AT3 that matches the extending direction of the first passage A1.

When the drive force transmission device 9 converts the drive force from the remote operating rod 200 into the rotary movement of the rotating body 97 about the rotation axis AT3, operation on the remote operating rod 200 enables the wire stripper 1 to be rotated about the sheathed wire C arranged in the first passage A1. In such a case, by operating the remote operating rod 200, it is possible to perform stripping work on the sheathed wire C.

Further, when the drive force transmission device 9 converts the drive force from a motor into the rotary movement of the rotating body 97 about the rotation axis AT3, the use of the drive force of the motor enables the wire stripper 1 to be rotated about the sheathed wire C arranged in the first passage A1. In such a case, the use of the drive force from the motor enables stripping work on the sheathed wire C to be performed automatically or semi-automatically.

An example of a mechanism to convert external drive force into rotary movement of the rotating body 97 about the rotation axis AT3 will be described. In the example illustrated in FIG. 21, the drive force transmission device 9 of the wire stripping device 100 has a first bevel gear 91, a second bevel gear 93, a first gear 95g, and a second gear 97g. Further, the second gear 97g forms at least a part of the rotating body 97 described above.

The first bevel gear 91 is rotated about a first axis AT1 by external drive force. In the example illustrated in FIG. 21, when the remote operating rod 200 is turned and operated, the first bevel gear 91 is rotated about the first axis AT1 by the remote operating rod 200. Alternatively, the first bevel gear 91 may be rotated about the first axis AT1 by drive force of a motor.

The second bevel gear 93 is engaged with the first bevel gear 91. Thus, rotation of the first bevel gear 91 about the first axis AT1 causes rotation of the second bevel gear 93 about a second axis AT2. In the example illustrated in FIG. 21, the second axis AT2 is perpendicular to the first axis AT1. Further, the second axis AT2 is parallel to the extending direction of the first passage A1.

In the example illustrated in FIG. 21, the second bevel gear 93 is fixed to the first gear 95g via a shaft 94. In such a case, rotation of the second bevel gear 93 about the second axis AT2 causes rotation of the shaft 94 and the first gear 95g about the second axis AT2.

In the example illustrated in FIG. 21, the first gear 95g is engaged with the second gear 97g. Rotation of the first gear 95g about the second axis AT2 causes rotation of the second gear 97g (in other words, the rotating body 97) about a rotation axis AT3 parallel to the second axis AT2. In the example illustrated in FIG. 21, the rotation axis AT3 matches the extending direction of the first passage A1.

In the example illustrated in FIG. 21, the wire stripper 1 is attached to the second gear 97g (in other words, the rotating body 97) via the attaching part 99. Therefore, rotation of the second gear 97g (in other words, the rotating body 97) about the rotation axis AT3 causes rotation of the wire stripper 1 about the first passage A1 that is coaxial with the rotation axis AT3. The wire stripper 1 is rotated about the first passage A1, and thereby the blade body 50 strips the sheath layer C1 from the sheathed wire C.

In the example illustrated in FIG. 21, a first end 81a of the support block 81 of the wire stripper 1 is attached to the attaching part 99 of the drive force transmission device 9. In the example illustrated in FIG. 21, it is preferable that one of the first end 81a and the second end 81b of the support block 81 can be selectively attached to the attaching part 99 of the drive force transmission device 9. In the example illustrated in FIG. 21, when the second end 81b of the support block 81 is attached to the attaching part 99, the extending direction of the second passage A2 (see FIG. 17, if necessary) of the wire stripper 1 matches the rotation axis AT3 of the rotating body 97 (more specifically, the second gear 97g). In such a case, the drive force transmission device 9 can convert external drive force (for example, drive force from the remote operating rod 200 or drive force from a motor) into rotary movement of the rotating body 97 about the rotation axis AT3 that matches the extending direction of the second passage A2.

### Wire Stripping Method

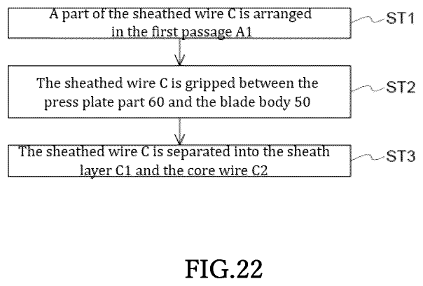

A wire stripping method of an embodiment will be described with reference to FIG. 1 to FIG. 22. FIG. 22 is a flowchart illustrating an example of the wire stripping method of the embodiment.

In the wire stripping method of the embodiment, the sheath layer C1 is stripped from the sheathed wire C by using the wire stripper 1. The wire stripper 1 used in the wire stripping method of the embodiment may be the wire stripper 1A of the first embodiment, may be the wire stripper 1B of the second embodiment, or may be other wire strippers. Further, in the wire stripping method of the embodiment, the wire stripping device 100 of the third embodiment may be used.

As illustrated in FIG. 1, FIG. 20, FIG. 21, or the like as examples, the wire stripper 1 has (1) the wire stripper body 2 having the first member 3, the second member 4 arranged facing the first member 3, and the first passage A1 defined by the first member 3 and the second member 4 and configured to receive a part of the sheathed wire C to be arranged, (2) the blade body 50 attached to the second member 4, and (3) the press plate part 60 arranged to the first member 3 so as to face the blade body 50 and having the press surface 62 configured to press the sheathed wire C against the blade body 50. (4) The first member 3 has the first guide part 31 defining a part of the first passage A1 and configured to guide relative motion of the wire stripper body 2 relative to the sheathed wire C.

Since the wire stripper body 2, the blade body 50, the press plate part 60, and the first guide part 31 have already been described in the first embodiment, the duplicated description for the configurations thereof will be omitted.

In first step ST1, a part of the sheathed wire C is arranged in the first passage A1. The first step ST1 is an arrangement step.

In the example illustrated in FIG. 3, the arrangement step includes inserting a part of the sheathed wire C from outside of the wire stripper body 2 into the first passage A1 via the first side opening OP1 between the first member 3 and the second member 4. Note that, when the sheathed wire C is an overhead line, the arrangement step is performed by moving the wire stripper body 2 toward the sheathed wire C that is the overhead line.

As illustrated in FIG. 4, FIG. 20, FIG. 21, or the like as examples, in second step ST2, the sheathed wire C is gripped between the press plate part 60 and the blade body 50. The second step ST2 is a gripping step. In the gripping step, by reducing the distance between the first member 3 and the second member 4, the sheathed wire C is gripped between the press plate part 60 arranged to the first member 3 and the blade body 50 attached to the second member 4.

In the gripping step, the reduction of the distance between the first member 3 and the second member 4 is performed by operating the operating part 75 in the first operation direction MR1. More specifically, as illustrated in FIG. 4 as an example, when the operating part 75 is operated in the first operation direction MR1, and the threaded rod 71 having the threaded part 71a and the reverse threaded part 71b is rotated. As a result, both the first member 3 screwed onto the threaded part 71a and the second member 4 screwed onto the reverse threaded part 71b are moved closer to the center of the first passage A1.

As illustrated in FIG. 13 as an example, in third step ST3, the sheathed wire C is separated into the sheath layer C1 and the core wire C2. The third step ST3 is a separation step. In the separation step, the wire stripper body 2 is relatively rotated with respect to the sheathed wire C, and thereby the sheathed wire C is separated into the sheath layer C1 and the core wire C2 by the blade body 50.

In the example illustrated in FIG. 13, in the separation step, the wire stripper body 2 is relatively rotated in the first rotation direction AR1 with respect to the sheathed wire C. Because the wire stripper body 2 is relatively rotated in the first rotation direction AR1 with respect to the sheathed wire C, the blade body 50 attached to the second member 4 of the wire stripper body 2 is relatively rotated in the first rotation direction AR1 with respect to the sheathed wire C. Accordingly, the blade body 50 separates the sheathed wire C into the sheath layer C1 and the core wire C2.

The relative rotation of the wire stripper body 2 in the first rotation direction AR1 with respect to the sheathed wire C may be performed manually or may be performed by using drive force of a motor. Further, the relative rotation of the wire stripper body 2 in the first rotation direction AR1 with respect to the sheathed wire C may be performed by using the drive force transmission device 9 that converts external drive force into rotary movement of the rotating body 97 supporting the wire stripper 1 (see FIG. 21, if necessary).

As illustrated in FIG. 4, FIG. 20, FIG. 21, or the like as examples, the press plate part 60 of the first member 3 protrudes on the first passage A1 side from the first guide part 31 of the first member 3. More specifically, the press plate part 60 of the first member 3 protrudes on the first passage A1 side from any of the plurality of guide plates 310 of the first member 3. Therefore, in a state immediately after the gripping step (second step ST2) described above is performed, the force of the press plate part 60 pressing the sheathed wire C is larger than the force of the first guide part 31 pressing the sheathed wire C. Therefore, in the separation step (third step ST3), when the wire stripper body 2 is relatively rotated with respect to the sheathed wire C, the relative motion of the wire stripper body 2 relative to the sheathed wire C is not obstructed by the first guide part 31.

In the example illustrated in FIG. 9 or the like, when viewed in a direction along the second direction DR2, the press plate part 60 is inclined with respect to the third direction DR3. In such a case, in the initial phase of the separation step, the press plate part 60 in contact with the sheathed wire C assists the helical movement of the wire stripper body 2 relative to the sheathed wire C. More specifically, when the press plate part 60 is inclined so as to correspond to a part of the helix of right-hand thread, the press plate part 60 in contact with the sheathed wire C assists the helical movement of the wire stripper body 2 in a right-hand thread proceeding direction. In contrast, when the press plate part 60 is inclined so as to correspond to a part of the helix of left-hand thread, the press plate part 60 in contact with the sheathed wire C assists the helical movement of the wire stripper body 2 in a left-hand thread proceeding direction.

In the example illustrated in FIG. 2, FIG. 21, or the like, the blade edge 50e of the blade body 50 is inclined away from the first passage A1 toward the first direction DR1. In such a case, in the initial phase of the separation step, the press plate part 60 and the blade body 50 in contact with the sheathed wire C cooperate with each other to assist the helical movement of the wire stripper body 2 relative to the sheathed wire C. More specifically, when the wire stripper body 2 is relatively rotated with respect to the sheathed wire C, the press plate part 60 and the blade body 50 cooperate with each other to apply driving force to the wire stripper body 2 so that the wire stripper body 2 is relatively moved in the fifth direction DR5 with respect to the sheathed wire C.

In the example illustrated in FIG. 13, the press plate part 60 is configured to be spaced apart from the sheathed wire C when the separation step is performed. The press plate part 60 may be configured to be spaced apart from the sheathed wire C after the wire stripper body 2 is relatively rotated by 360 degrees or more or 720 degrees or more with respect to the sheathed wire C in the separation step.

In the example illustrated in FIG. 13, in the separation step, in response to relative rotation of the wire stripper body 2 with respect to the sheathed wire C with the press plate part 60 being spaced apart from the sheathed wire C, the blade body 50 and the first guide part 31 in contact with the sheathed wire C cooperate with each other to assist the helical movement of the wire stripper body 2 relative to the sheathed wire C.

In the example illustrated in FIG. 13, the blade edge 50e of the blade body 50 is inclined away from the first passage A1 toward the first direction DR1. In such a case, in a state where the press plate part 60 is spaced apart from the sheathed wire C, the blade body 50 and the first guide part 31 in contact with the sheathed wire C cooperate with each other to assist the helical movement of the wire stripper body 2 relative to the sheathed wire C. More specifically, when the wire stripper body 2 is relatively rotated with respect to the sheathed wire C, the blade body 50 and the first guide part 31 in contact with the sheathed wire C cooperate with each other to apply driving force to the wire stripper body 2 so that the wire stripper body 2 is relatively moved in the fifth direction DR5 with respect to the sheathed wire C. Accordingly, the blade body 50 and the first guide part 31 cooperate with each other to assist the helical movement of the wire stripper body 2 relative to the sheathed wire C.

As illustrated in FIG. 10 as an example, the first guide part 31 may have the inclined guide plate GP inclined with respect to the third direction DR3 when viewed in a direction along the second direction DR2. In such a case, in a state where the press plate part 60 is spaced apart from the sheathed wire C, the inclined guide plate GP in contact with the sheathed wire C can assist the helical movement of the wire stripper body 2 relative to the sheathed wire C. More specifically, when the inclined guide plate GP is inclined so as to correspond to a part of the helix of right-hand thread, the inclined guide plate GP in contact with the sheathed wire C assists the helical movement of the wire stripper body 2 in the right-hand thread proceeding direction. In contrast, when the inclined guide plate GP is inclined so as to correspond to a part of the helix of left-hand thread, the inclined guide plate GP in contact with the sheathed wire C assists the helical movement of the wire stripper body 2 in the right-hand thread proceeding direction.

In the initial phase of the separation step, when the press plate part 60 and the blade body 50 assist the helical movement of the wire stripper body 2 relative to the sheathed wire C, and the blade body 50 and the first guide part 31 then assist the helical movement of the wire stripper body 2 relative to the sheathed wire C, stripping work on the sheath layer C1 can be performed continuously and smoothly.

The present invention is not limited to each embodiment or each modified example described above, and it is apparent that each embodiment or each modified example can be suitably modified or changed within the scope of the technical concept of the present invention. Further, any component used in each embodiment or each modified example can be combined with another embodiment or another modified example, and any component can be omitted in each embodiment or each modified example.

For example, in the example illustrated in FIG. 3, FIG. 20, and FIG. 21, let us assume a case where the sheathed wire C is arranged in the first passage A1, then the operating part 75 is operated, and thereby the distance between the first member 3 and the second member 4 is reduced. In such a case, due to the operation on the operating part 75 or the like, the wire stripper 1 may swing. Further, due to the swinging of the wire stripper 1, the sheathed wire C may fall out of the wire stripper 1 via the first side opening OP1 between the first member 3 and the second member 4.

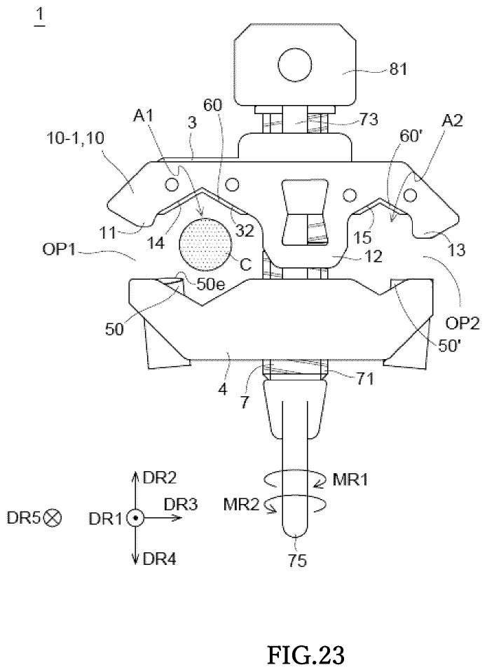

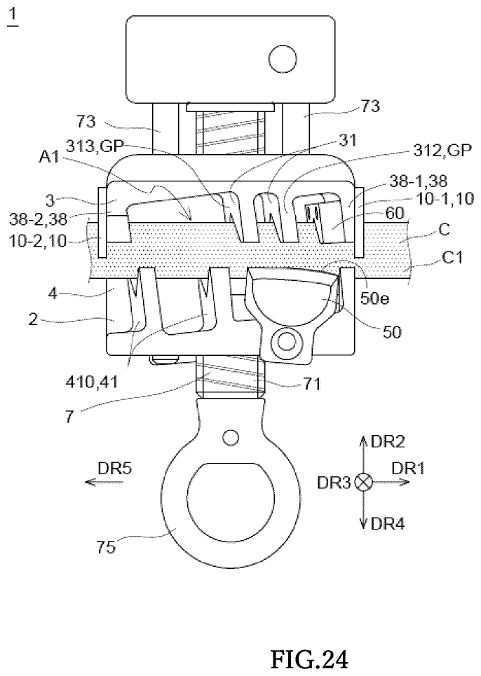

To address the above, as illustrated in FIG. 23 as an example, the wire stripper 1 of the embodiment may have an anti-falling-off plate 10 that prevents the sheathed wire C from falling off of the first passage A1 via the first side opening OP1 between the first member 3 and the second member 4. In the example illustrated in FIG. 24, the anti-falling-off plate 10 is attached to an end 38 of the first member 3 in a direction along the first passage A1. As illustrated in FIG. 24 as an example, the anti-falling-off plate 10 may include a first anti-falling-off plate 10-1 attached to an end 38-1 on the first direction DR1 side of the first member 3 and a second anti-falling-off plate 10-2 attached to an end 38-2 on the fifth direction DR5 side of the first member 3. When the anti-falling-off plate 10 is arranged to each of both ends of the first member 3, the sheathed wire C is more reliably prevented from falling off of the first passage A1.

In the example illustrated in FIG. 23, the anti-falling-off plate 10 has a first protruding part 11 protruding on the first side opening OP1 side when viewed in a direction along the first passage A1. The first protruding part 11 prevents or suppresses the sheathed wire C arranged in the first passage A1 from moving so as to pass through the first side opening OP1 between the first member 3 and the second member 4. Additionally, the anti-falling-off plate 10 may have a second protruding part 12 that prevents the sheathed wire C arranged in the first passage A1 from displacing to the opposite side from the side on which the first side opening OP1 is located. Further, the anti-falling-off plate 10 may have a third protruding part 13 that prevents or suppresses the second sheathed wire C′ (see FIG. 17, if necessary) arranged in the second passage A2 from moving so as to pass through the second side opening OP2 between the first member 3 and the second member 4.

In the example illustrated in FIG. 23 and FIG. 24, the anti-falling-off plate 10 (more specifically, the first anti-falling-off plate 10-1 and the second anti-falling-off plate 10-2) is attached to the first member 3. Alternatively or additionally, the anti-falling-off plate 10 (more specifically, the first anti-falling-off plate 10-1 and the second anti-falling-off plate 10-2) may be attached to the second member 4.

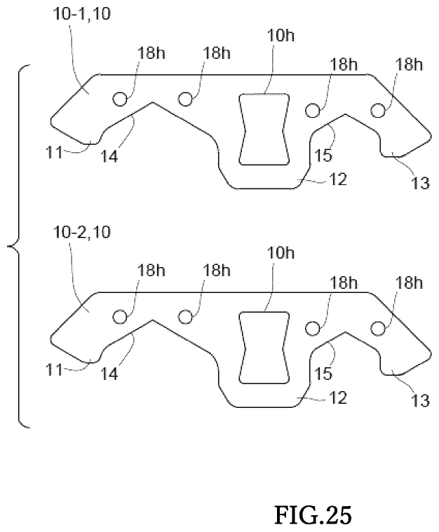

Note that it is also possible that a portion having the same shape as the anti-falling-off plate 10 is formed integrally with the first member 3 (or the second member 4). In terms of easier manufacturing and in terms of weight reduction, however, as illustrated in FIG. 25, the anti-falling-off plate 10 is preferably a component detachable from the first member 3 (or the second member 4). To further reduce the weight of the anti-falling-off plate 10, a through-hole 10h may be formed in the anti-falling-off plate 10. Further, the anti-falling-off plate 10 may have attaching holes 18h used for attaching the anti-falling-off plate 10 to the first member 3 (or the second member 4). In the example illustrated in FIG. 25, the size of each attaching hole 18h is smaller than the size of the through-hole 10h provided for weight reduction.

In the example illustrated in FIG. 25, the anti-falling-off plate 10 is provided with a first recess 14 between the first protruding part 11 and the second protruding part 12. The first recess 14 may be a V-shaped recess. In the example illustrated in FIG. 23, when viewed in a direction along the first passage A1, the first recess 14 has a shape substantially corresponding to the outer edge of the first passage A1. In such a case, when the wire stripper 1 is relatively moved in the direction along the first passage A1 with respect to the sheathed wire C, this relative motion is not obstructed by the anti-falling-off plate 10.

In the example illustrated in FIG. 25, the anti-falling-off plate 10 is provided with a second recess 15 between the second protruding part 12 and the third protruding part 13. The second recess 15 may be a V-shaped recess. In the example illustrated in FIG. 23, when viewed in a direction along the second passage A2, the second recess 15 has a shape substantially corresponding to the outer edge of the second passage A2. In such a case, when the wire stripper 1 is relatively moved in a direction along the second passage A2 with respect to the second sheathed wire, this relative motion is not obstructed by the anti-falling-off plate 10.

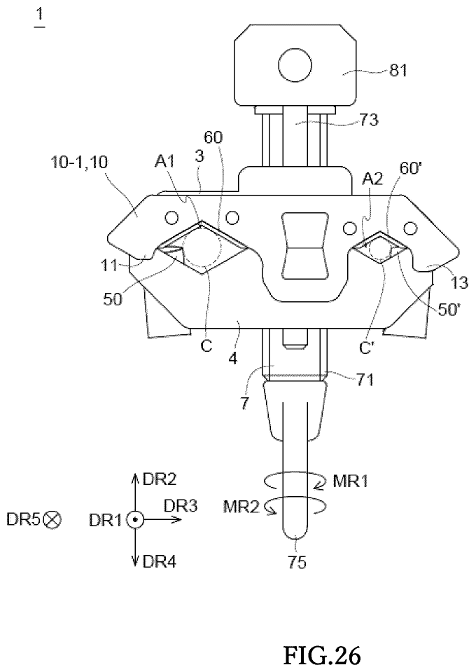

In the example illustrated in FIG. 26, the example is configured such that, in a state where the distance between the first member 3 and the second member 4 is reduced to the least distance by operation on the operating part 75, a part of the anti-falling-off plate 10 (for example, the first protruding part 11 and/or the third protruding part 13) attached to one of the first member 3 and the second member 4 overlaps the other of the first member 3 and the second member 4 when viewed in a direction along the first passage A1.

For example, in the example illustrated in FIG. 26, the example is configured such that, in a state where the distance between the first member 3 and the second member 4 is reduced to the least distance by operation on the operating part 75, the first protruding part 11 of the anti-falling-off plate 10 attached to the first member 3 overlaps the second member 4. In such a case, the sheathed wire C having a relatively small diameter is reliably prevented from falling out of the first passage A1 from the first passage A1 by the anti-falling-off plate 10.

Further, in the example illustrated in FIG. 26, the example is configured such that, in a state where the distance between the first member 3 and the second member 4 is reduced to the least distance by operation on the operating part 75, the third protruding part 13 of the anti-falling-off plate 10 attached to the first member 3 overlaps the second member 4. In such a case, the second sheathed wire having a relatively small diameter is reliably prevented from falling out of the second passage A2 from the second passage A2 by the anti-falling-off plate 10.

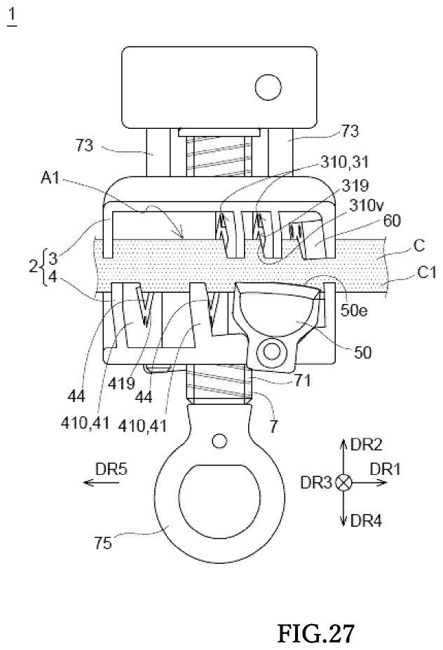

As illustrated in FIG. 27 as an example, the configuration may be such that the helical movement of the wire stripper body 2 relative to the sheathed wire C for stripping the sheath layer C1 from the sheathed wire C is assisted by the auxiliary guide part 41 of the second member 4.

More specifically, in the example illustrated in FIG. 27, the second member 4 has the auxiliary guide part 41 that defines a part of the first passage A1 and guides relative motion of the wire stripper body 2 relative to the sheathed wire C. Further, the auxiliary guide part 41 has the plate part 410 inclined so as to assist the helical movement of the wire stripper body 2 relative to the sheathed wire C.

In the example illustrated in FIG. 27, the example is configured such that, when viewed in the fifth direction DR5 (in other words, when viewed in a direction opposite to the direction of entry of the sheathed wire C into the first passage A1 in stripping of the sheathed wire C), the wire stripper body 2 is rotated to the right with respect to the sheathed wire C (in other words, rotated clockwise), and thereby the sheath layer C1 is stripped from the sheathed wire C. Further, in the example illustrated in FIG. 27, the auxiliary guide part 41 has the plate part 410 inclined so as to correspond to a part of the helix of right-hand thread. Therefore, in the example illustrated in FIG. 27, when the wire stripper body 2 is rotated to the right with respect to the sheathed wire C, the auxiliary guide part 41 assists the helical movement of the wire stripper body 2 relative to the sheathed wire C, the wire stripper body 2 is relatively rotated with respect to the sheathed wire C, and the wire stripper body 2 is relatively moved in the fifth direction DR5 with respect to the sheathed wire C. Alternatively, when the example is configured such that the wire stripper body 2 is rotated to the left with respect to the sheathed wire C and thereby the sheath layer C1 is stripped from the sheathed wire C when viewed in the fifth direction DR5, the example can be configured such that the auxiliary guide part 41 has the plate part 410 inclined so as to correspond to a part of the helix of left-hand thread.

In the example illustrated in FIG. 27, the first guide part 31 has the guide plate 310 inclined so as to correspond to a part of the helix of right-hand thread, and the auxiliary guide part 41 has the plate part 410 inclined so as to correspond to a part of the helix of right-hand thread. In such a case, the helical movement of the wire stripper body 2 relative to the sheathed wire C is more preferably assisted. Note that, when the example is configured such that the wire stripper body 2 is rotated to the left with respect to the sheathed wire C and thereby the sheath layer C1 is stripped from the sheathed wire C when viewed in the fifth direction DR5, the example can be configured such that the first guide part 31 has the guide plate 310 inclined so as to correspond to a part of the helix of left-hand thread and the auxiliary guide part 41 has the plate part 410 inclined so as to correspond to a part of the helix of left-hand thread.

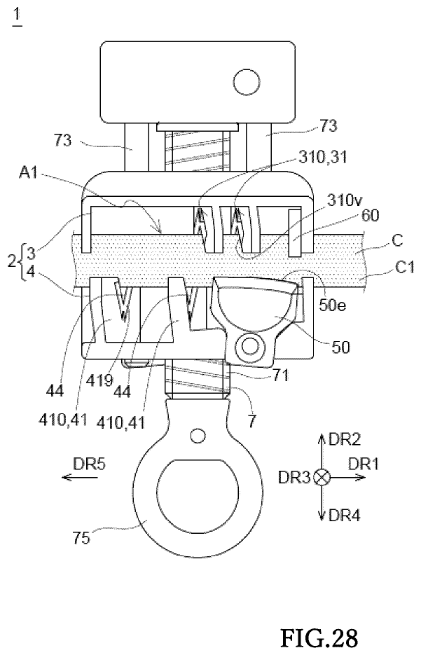

In the example illustrated in FIG. 27, the press plate part 60 is also inclined so as to correspond to a part of the helix of right-hand thread. Therefore, the helical movement of the wire stripper body 2 relative to the sheathed wire C is more preferably assisted. Alternatively, as illustrated in FIG. 28 as an example, the press plate part 60 is not necessarily required to be inclined with respect to a plane perpendicular to the first direction DR1. Also in such a case, the helical movement of the wire stripper body 2 relative to the sheathed wire C is assisted by the blade body 50, the guide plate 310 inclined so as to correspond to a part of the helix of right-hand thread, and the plate part 410 inclined so as to correspond to a part of the helix of right-hand thread.

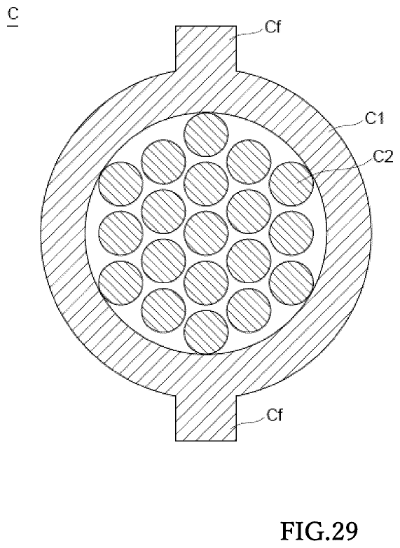

When the form in which the helical movement of the wire stripper body 2 relative to the sheathed wire C is assisted by the inclination of the guide plate 310 of the first guide part 31 and/or the inclination of the plate part 410 of the auxiliary guide part 41 is employed, it is also possible to smoothly strip the sheath layer C1 from the sheathed wire C having fin parts Cf as illustrated in FIG. 29 as an example.

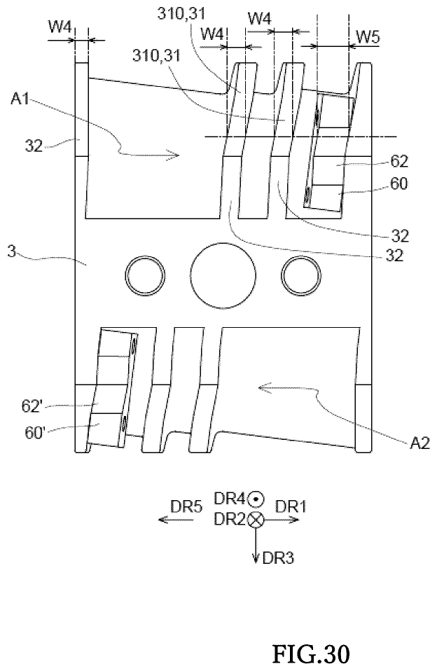

In terms of enabling smooth guidance of the sheathed wire C having the fin part Cf, a smaller width W4 (see FIG. 30) of the guide surface 32 of the first guide part 31 is preferable. When the width W4 of the guide surface 32 is small, this can cause only a small rotation resistance received by the guide surface 32 from the fin part Cf.

In particular, a smaller width W4 of the guide surface 32 of the guide plate 310 arranged on the fifth direction DR5 side (in other words, on the side of the direction opposite to the first direction DR1) from the press plate part 60 is preferable.

In the example illustrated in FIG. 30, the first guide part 31 has the guide plate 310 that guides the sheathed wire C, and this guide plate 310 has the guide surface 32 that faces the second member 4 (see FIG. 6 or the like, if necessary) and can come into contact with the sheathed wire C. Further, the width W4 of this guide surface 32 in the direction along the first passage A1 is smaller than the width W5 of the press surface 62 in the direction along the first passage A1. When the width W4 of the guide surface 32 is relatively small, this causes only a small rotation resistance received by the guide surface 32 from the fin part Cf. Further, when the width W5 of the press surface 62 is relatively large, this prevents the press surface 62 from excessively biting into the sheathed wire C when the wire stripper body 2 is set to the sheathed wire C.

The width W4 of this guide surface 32 in the direction along the first passage A1 is, for example, 3 mm or less, 2 mm or less, or 1 mm or less. In the example illustrated in FIG. 30, the width W4 in the direction along the first passage A1 of the guide surface 32 of each guide plate 310 is smaller than the width W5 of the press surface 62 in the direction along the first passage A1 for all the guide plates 310 arranged on the fifth direction DR5 side from the press plate part 60.

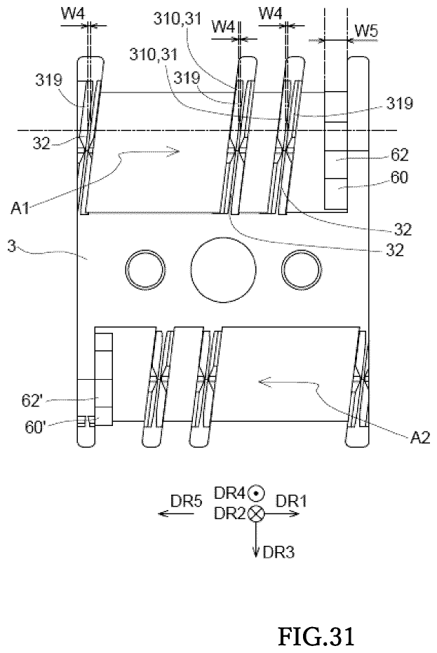

In the example illustrated in FIG. 30, the width of the guide plate 310 in the direction along the first passage A1 is substantially constant in the fourth direction DR4. Alternatively, as illustrated in FIG. 31 as an example, the width of the guide plate 310 in the direction along the first passage A1 may be reduced toward the fourth direction DR4. In other words, the guide plate 310 may have a tapered part 319 whose width in the direction along the first passage A1 becomes smaller toward the fourth direction DR4. In such a case, the width W4 of the guide surface 32 can be relatively smaller, and the width of the root of the guide plate 310 can be relatively larger. A larger width of the root of the guide plate 310 increases the strength of the guide plate 310.

In the example illustrated in FIG. 31, the width W4 of the guide surface 32 of the guide plate 310 in the direction along the first passage A1 is, for example, 3 mm or less, 2 mm or less, or 1 mm or less. In the example illustrated in FIG. 31, the width W4 in the direction along the first passage A1 of the guide surface 32 of each guide plate 310 is smaller than the width W5 of the press surface 62 in the direction along the first passage A1 for all the guide plates 310 arranged on the fifth direction DR5 side from the press plate part 60.

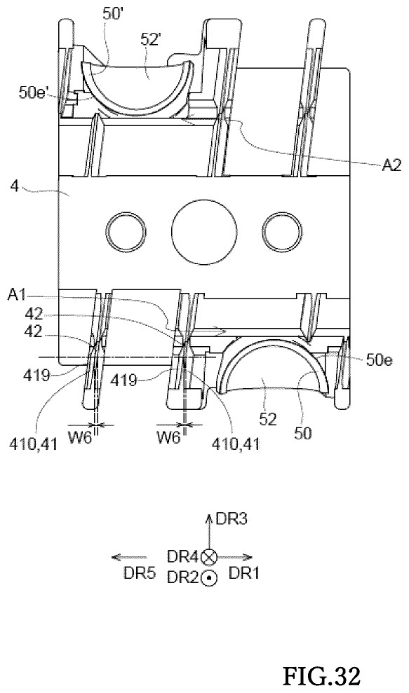

In terms of enabling smooth guidance of the sheathed wire C having the fin part Cf, a smaller width W6 (see FIG. 32) of the auxiliary guide surface 42 of the auxiliary guide part 41 is preferable. When the width W6 of the auxiliary guide surface 42 is small, this causes only a small rotation resistance received by the auxiliary guide surface 42 from the fin part Cf.

In particular, a smaller width W6 of the auxiliary guide surface 42 of the auxiliary guide part 41 arranged on the fifth direction DR5 side (in other words, on the side of the direction opposite to the first direction DR1) from the blade body 50 is preferable.

In the example illustrated in FIG. 32, the auxiliary guide part 41 has the plate part 410 that guides the sheathed wire C, and this plate part 410 has the auxiliary guide surface 42 that faces the first member 3 (see FIG. 27 or the like, if necessary) and can come into contact with the sheathed wire C. Further, the width W6 of this auxiliary guide surface 42 in the direction along the first passage A1 is smaller than the width W5 (see FIG. 30 or FIG. 31) of the press surface 62 in the direction along the first passage A1. When the width W6 of the auxiliary guide surface 42 is relatively small, this causes only a small rotation resistance received by the auxiliary guide surface 42 from the fin part Cf. Further, when the width W5 of the press surface 62 is relatively large, this prevents the press surface 62 from excessively biting into the sheathed wire C when the wire stripper body 2 is set to the sheathed wire C.

The width W6 of this auxiliary guide surface 42 in the direction along the first passage A1 is, for example, 3 mm or less, 2 mm or less, or 1 mm or less. In the example illustrated in FIG. 32, the width W6 in the direction along the first passage A1 of the auxiliary guide surface 42 of each plate part 410 is smaller than the width W5 of the press surface 62 in the direction along the first passage A1 for the plate parts 410 of all the auxiliary guide parts 41 arranged on the fifth direction DR5 side from the blade body 50.

In the example illustrated in FIG. 32, the plate part 410 of the auxiliary guide part 41 has a tapered part 419 whose width in the direction along the first passage A1 becomes smaller toward the second direction DR2. Alternatively, the width of the guide plate 310 in the direction along the first passage A1 may be substantially constant in the second direction DR2.

### Test Result of Wire Stripping Test

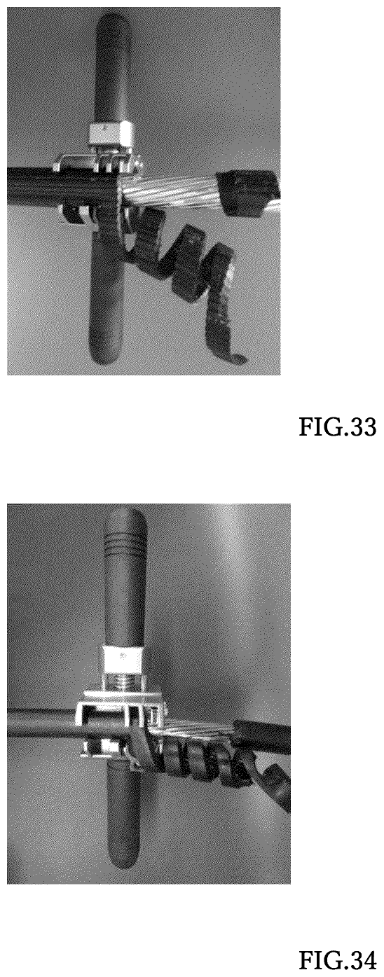

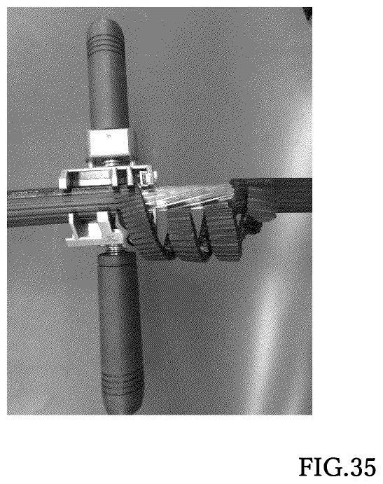

The wire stripper 1 of the embodiment was used to perform work to strip the sheath layer C1 from the sheathed wire C. FIG. 33 illustrates the result of Test 1, FIG. 34 illustrates the result of Test 2, and FIG. 35 illustrates the result of Test 3. In all of Test 1, Test 2, and Test 3, the same wire stripper 1 was used. Further, in all of Test 1, Test 2, and Test 3, the wire stripping test was performed with the sheathed wire C being arranged in the same first passage A1 of the wire stripper 1. Further, in all of Test 1, Test 2, and Test 3, the wire stripping test was performed with the same blade body 50 being attached at the same position to the wire stripper body 2 of the wire stripper 1.

In FIG. 33 (in other words, in Test 1), the outer diameter of the sheathed wire C arranged in the first passage A1 of the wire stripper body 2 was 30 mm, the outer diameter of the core wire C2 was 24 mm, and the thickness of the sheath layer C1 was 3 mm. In FIG. 34 (in other words, in Test 2), the outer diameter of the sheathed wire C arranged in the first passage A1 of the wire stripper body 2 was 20 mm, the outer diameter of the core wire C2 was 13 mm, and the thickness of the sheath layer C1 was 3.5 mm. In FIG. 35 (in other words, in Test 3), the outer diameter of the sheathed wire C arranged in the first passage A1 of the wire stripper body 2 was 23 mm, the outer diameter of the core wire C2 was 17 mm, and the thickness of the sheath layer C1 was 3 mm.

In the wire stripper 1 used in Test 1 to Test 3, the press plate part 60 protruded on the first passage A1 side from the first guide part 31. Further, when the direction of entry of the sheathed wire C into the first passage A1 in stripping of the sheathed wire C is defined as the first direction DR1, the blade edge of the blade body 50 was inclined away from the first passage A1 toward the first direction DR1. Further, when the direction from the first member 3 to the second member 4 is defined as the fourth direction DR4, the blade edge of the blade body 50 had a substantially circular-arc shape when viewed in a direction along the fourth direction DR4.

It was confirmed in Test 1, Test 2, and Test 3 that the sheath layers C1 of the sheathed wires C having different sizes are suitably stripped by using a single wire stripper 1 without changing the position of the blade body 50. It was confirmed in each test that the press plate part 60 suitably presses the sheathed wire C in the initial phase of stripping. It was confirmed that, after the initial phase, the press plate part 60 faces the core wire C2 exposed from the sheath layer C1 and does not obstruct the relative motion of the sheathed wire C in the first direction DR1 relative to the wire stripper body 2. Further, it was confirmed that, because the blade edge of the blade body 50 is inclined away from the first passage A1 toward the first direction DR1, the helical movement of the wire stripper body 2 relative to the sheathed wire Cis suitably performed.

### INDUSTRIAL APPLICABILITY

The use of the wire stripper, the wire stripping device, or the wire stripping method of the present invention enables smooth stripping work to be performed on a sheath layer. Therefore, the wire stripper, the wire stripping device, and the wire stripping method of the present invention are useful for business entities that use wire strippers or wire stripping devices to perform their work or operation and manufacturers that manufacture wire strippers or wire stripping devices.

### LIST OF REFERENCE SYMBOLS

1, 1A, 1B wire stripper
2 wire stripper body
3 first member
4 second member
7 distance adjusting member
9 drive force transmission device
10 anti-falling-off plate
10-1 first anti-falling-off plate
10-2 second anti-falling-off plate
10h through-hole
11 first protruding part
12 second protruding part
13 third protruding part
14 first recess
15 second recess
18h attaching hole
31 first guide part
31′ second guide part
32, 32′ guide surface
35 top wall
35′ second top wall
35n inner surface
36 first block part
36h first threaded hole
38 end
38-1 first end
38-2 second end
41 auxiliary guide part
41′ second auxiliary guide part
42 auxiliary guide surface
44 recess
45 top wall
45′ second top wall
45n inner surface
46 second block part
46h second threaded hole
48 attachment receiving part
48d recess
48h hole
49 fastening member
50 blade body
50′ second blade body
50e blade edge
50e′ second blade edge
52 scoop part
52′ second scoop part
54 attaching part
60 press plate part
60′ second press plate part
60h attaching hole
62 press surface
62′ second press surface
64, 64′ groove
68 fastening member
71 threaded rod
71a threaded part
71b reverse threaded part
73 guide rod
73a first guide rod
73b second guide rod
75 operating part
81 support block
81a first end
81b second end
91 first bevel gear
93 second bevel gear
94 shaft
95g first gear
97 rotating body
97g second gear
99 attaching part
100 wire stripping device
200 remote operating rod
310, 310′ guide plate
310v, 310v′ guide groove
311 first guide plate
311h hole
311v first guide groove
312 second guide plate
312v second guide groove
313 third guide plate
313v third guide groove
314 fourth guide plate
314v fourth guide groove
319 tapered part
351n inclined surface
371h guide hole
372h second guide hole
410, 410′, 410a, 410b plate part
419 tapered part
451n inclined surface
471h guide hole
472h second guide hole
750 operating ring
752 handle
752a first operating handle
752b second operating handle
A1 first passage
A2 second passage
C sheathed wire
C′ second sheathed wire
C1 sheath layer
C1′ second sheath layer
C2 core wire
Cf fin part
GP, GP′ inclined guide plate
OP1 first side opening
OP2 second side opening
P1 first pocket
P2 second pocket
P3 third pocket

1. A wire stripper comprising:
a wire stripper body having a first member, a second member arranged facing the first member, and a first passage defined by the first member and the second member and configured to receive a part of a sheathed wire to be arranged;
a blade body attached to the second member and configured to separate the sheathed wire into a sheath layer and a core wire when the wire stripper body is relatively rotated with respect to the sheathed wire;
a press plate part arranged to the first member so as to face the blade body and having a press surface configured to press the sheathed wire against the blade body; and
a distance adjusting member configured to adjust the distance between the first member and the second member,
wherein the first member has a first guide part defining a part of the first passage and configured to guide relative motion of the wire stripper body relative to the sheathed wire, and
wherein the press plate part protrudes on the first passage side from the first guide part.

2. The wire stripper according to claim 1,
wherein the second member has an auxiliary guide part defining a part of the first passage and configured to guide the relative motion of the wire stripper body relative to the sheathed wire, and
wherein when viewed in a direction along the first passage, the diameter of a first virtual circular cylinder inscribed in both the press plate part and the auxiliary guide part is smaller than the diameter of a second virtual circular cylinder inscribed in both the first guide part and the auxiliary guide part.

3. The wire stripper according to claim 1, wherein when viewed in a direction along the first passage, the press surface has a V-shape.

4. The wire stripper according to claim 1, wherein a direction parallel to the first passage is defined as a first direction, a direction from the second member to the first member is defined as a second direction, and a direction perpendicular to both the first direction and the second direction is defined as a third direction, and when viewed in a direction along the second direction, the press plate part is inclined with respect to the third direction.

5. The wire stripper according to claim 1,
wherein the first guide part has a guide plate configured to guide the sheathed wire, and
wherein the guide plate has a V-shaped guide groove.

6. The wire stripper according to claim 1, wherein the first guide part has an inclined guide plate configured to assist helical movement of the wire stripper body relative to the sheathed wire.

7. The wire stripper according to claim 6,
wherein the first member has a top wall supporting the first guide part, and
wherein the inner surface of the top wall is inclined with respect to the first passage so as to be substantially perpendicular to the inclined guide plate.

8. The wire stripper according to claim 1,
wherein a direction in which the sheathed wire enters the first passage in stripping of the sheathed wire is defined as a first direction, and a blade edge of the blade body is inclined away from the first passage toward the first direction, and
wherein a direction from the first member to the second member is defined as a fourth direction, and when viewed in a direction along the fourth direction, the blade edge of the blade body has a substantially circular-arc shape.

9. The wire stripper according to claim 1, wherein the press plate part is detachably attached to the first member.

10. The wire stripper according to claim 1, wherein the distance adjusting member has
a threaded rod screwed into both the first member and the second member,
a guide rod inserted in both the first member and the second member and configured to guide relative motion of the first member relative to the second member, and
an operating part configured to relatively rotate the threaded rod with respect to both the first member and the second member.

11. The wire stripper according to claim 1 further comprising:
a second blade body attached to one of the first member and the second member and configured to separate a second sheathed wire into a second sheath layer and a second core wire, the second sheathed wire being thinner than the sheathed wire; and
a second press plate part arranged to the other of the first member and the second member so as to face the second blade body and having a second press surface configured to press the second sheathed wire against the second blade body,
wherein the wire stripper body has
a second passage defined by the first member and the second member and configured to receive a part of the second sheathed wire to be arranged, and
a second guide part arranged to the other of the first member and the second member so as to define a part of the second passage and configured to guide relative motion of the wire stripper body relative to the second sheathed wire, and
wherein the second press plate part protrudes on the second passage side from the second guide part.

12. The wire stripper according to claim 1 further comprising an anti-falling-off plate configured to prevent the sheathed wire from falling off of the first passage via a first side opening between the first member and the second member,
wherein the anti-falling-off plate is attached to at least one of an end of the first member in a direction along the first passage and an end of the second member in the direction along the first passage.

13. The wire stripper according to claim 1,
wherein the second member has an auxiliary guide part defining a part of the first passage and configured to guide the relative motion of the wire stripper body relative to the sheathed wire, and
wherein the auxiliary guide part has a plate part inclined so as to assist helical movement of the wire stripper body relative to the sheathed wire.

14. The wire stripper according to claim 1,
wherein the first guide part has a guide plate configured to guide the sheathed wire,
wherein the guide plate has a guide surface facing the second member and configured to come into contact with the sheathed wire, and
wherein the width of the guide surface in a direction along the first passage is smaller than the width of the press surface in the direction along the first passage.

15. A wire stripping device comprising:
the wire stripper according to claim 1; and
a drive force transmission device comprising a rotating body and an attaching part for attaching the wire stripper to the rotating body, the drive force transmission device being configured to convert external drive force into rotary movement of the rotating body about a rotation axis that matches an extending direction of the first passage.

16. A wire stripping method for stripping a sheath layer from a sheathed wire by using a wire stripper,
wherein the wire stripper comprises
a wire stripper body having a first member, a second member arranged facing the first member, and a first passage defined by the first member and the second member and configured to receive a part of a sheathed wire to be arranged,
a blade body attached to the second member, and
a press plate part arranged to the first member so as to face the blade body and having a press surface configured to press the sheathed wire against the blade body, and
wherein the first member has a first guide part defining a part of the first passage and configured to guide relative motion of the wire stripper body relative to the sheathed wire, and
the wire stripping method comprising:
an arrangement step of arranging a part of the sheathed wire in the first passage;
a gripping step of gripping the sheathed wire between the press plate part arranged to the first member and the blade body attached to the second member by reducing the distance between the first member and the second member; and
a separation step of separating the sheathed wire into the sheath layer and a core wire by the blade body by relatively rotating the wire stripper body with respect to the sheathed wire,
wherein in a state immediately after the gripping step, force of the press plate part pressing the sheathed wire is larger than force of the first guide part pressing the sheathed wire.

17. The wire stripping method according to claim 16,
wherein the press plate part is spaced apart from the sheathed wire by performing the separation step, and
wherein in the separation step, in response to relative rotation of the wire stripper body with respect to the sheathed wire with the press plate part being spaced apart from the sheathed wire, the blade body and the first guide part in contact with the sheathed wire cooperate with each other to assist helical movement of the wire stripper body relative to the sheathed wire.

18. A wire stripping device comprising:
the wire stripper according to claim 2; and
a drive force transmission device comprising a rotating body and an attaching part for attaching the wire stripper to the rotating body, the drive force transmission device being configured to convert external drive force into rotary movement of the rotating body about a rotation axis that matches an extending direction of the first passage.

19. A wire stripping device comprising:
the wire stripper according to claim 3; and
a drive force transmission device comprising a rotating body and an attaching part for attaching the wire stripper to the rotating body, the drive force transmission device being configured to convert external drive force into rotary movement of the rotating body about a rotation axis that matches an extending direction of the first passage.

20. A wire stripping device comprising:
the wire stripper according to claim 4; and
a drive force transmission device comprising a rotating body and an attaching part for attaching the wire stripper to the rotating body, the drive force transmission device being configured to convert external drive force into rotary movement of the rotating body about a rotation axis that matches an extending direction of the first passage.
